(19) United States
(12) Patent Application Publication
(10) Pub. No.: US 2026/0126372 A1
(43) Pub. Date: May 7, 2026

(54) FLOW CYTOMETER MODULE AND METHODS OF USE THEREOF

(71) Applicant: General Fluidics Corporation, Watertown, MA (US)

(72) Inventors: Robert Granier, Boston, MA (US); Ramin Haghgooie, Arlington, MA (US); Kenneth Thomas Kotz, Newton, MA (US); Michael David Sánchez, Bedford, VA (US); Daniel Morris Hartmann, Arlington, MA (US); Jesse Newton Jones, IV, Woburn, MA (US); Steven M. Scherr, Harvard, MA (US)

(21) Appl. No.: 19/383,023

(22) Filed: Nov. 7, 2025

Related U.S. Application Data
(60) Provisional application No. 63/717,782, filed on Nov. 7, 2024.

(51) Int. Cl. G01N 15/1434; G01N 15/1404; G01N 15/1409; G01N 15/1429

(52) U.S. Cl. CPC G01N 15/1436; G01N 15/1409; G01N 15/1429; G01N 2015/1418; G01N 2015/1452

(57) ABSTRACT

A module includes one or more focusing optics, a flowcell configured to receive one or more particles, a collimated laser configured to shine a beam of light through the one or more focusing optics onto the flowcell, wherein the one or more focusing optics is configured to provide a beam of light from the collimated laser that overfills a width of the flowcell a side scatter optical train which includes one or more optics and one or more side scatter detectors, wherein the one or more side scatter detectors are configured to receive light scattered by the one or more particles, a forward scatter optical train which includes a forward scatter mask, one or more optics, and one or more forward scatter detectors, wherein the one or more forward scatter detectors are configured to receive the scattered light.

### CROSS-REFERENCE TO RELATED APPLICATION(S)

This patent application claims the benefit of priority to U.S. Provisional Application No. 63/717,782, filed on Nov. 7, 2024, the entirety of which is incorporated herein by reference.

### TECHNICAL FIELD

Various embodiments of the present disclosure relate generally to flow cytometers and, more particularly, to flow cytometer modules and methods of use.

### BACKGROUND

Most hematology analyzers are flow cytometers that use sheath fluid to hydrodynamically focus cells in a flowcell for interrogation. Sheath fluid confines the sample of interest to a narrow stream, so that it can be interrogated with a small, focused beam of light. However, the use of sheath fluid requires additional hardware to pump the fluid through the flowcell, requires regular replacement, and greatly increases the volume of biohazardous waste that is generated. These factors serve to increase the cost-of-ownership of such systems.

To address these deficiencies, some commercially available cytometers do not utilize sheath-fluid, but instead use a micro-capillary to directly pull fluid from a sample cup into an interrogation region. This simplifies the fluidics and reduces the amount of waste generated, making the system lower-cost and more portable. However, because the laser in some commercially available cytometer systems is focused down to a small spot in the flowcell, some cells in the sample may not interact with the laser beam and are therefore not counted as they flow by. As such, the precision and absolute accuracy of cell counts made with certain cytometers are typically not as good as those made by cytometers that use sheath fluid.

The present disclosure is directed to overcoming one or more of these above-referenced challenges.

### SUMMARY OF THE DISCLOSURE

Aspects of the present disclosure include a flow cytometry module and related hardware for performing hematology measurements. Aspects of the present disclosure include a modular, sheathless flow cytometer and associated hardware.

In some aspects, the techniques described herein relate to a module including: one or more focusing optics; a flowcell configured to receive one or more particles therein; a collimated laser configured to shine a beam of light through the one or more focusing optics onto the flowcell; a side scatter optical train including one or more optics and one or more side scatter detectors, wherein the one or more side scatter detectors are configured to receive light scattered by the one or more particles in the flowcell; a forward scatter optical train including a forward scatter mask, one or more optics, and one or more forward scatter detectors, wherein the one or more forward scatter detectors are configured to receive the light scattered by particles flowing in the flowcell; and a processor configured to capture data from the one or more side scatter detectors and the one or more forward scatter detectors to determine at least one characteristic of the one or more particles received by the flowcell.

In some aspects, the techniques described herein relate to a module, wherein the one or more focusing optics includes a first lens and a second lens, wherein the second lens is a cylindrical lens.

In some aspects, the techniques described herein relate to a module, wherein the one or more focusing optics is configured to focus the beam from the collimated laser into an astigmatic beam onto the flowcell.

In some aspects, the techniques described herein relate to a module, wherein the one or more focusing optics is configured to provide a beam of light from the collimated laser that overfills a width of the flowcell, overlapping one or more channel edges of the flowcell, the beam of light having a size, uniformity, and intensity at the flowcell such that a full cross-sectional area of a channel within the flowcell is illuminated with the beam of the light that is substantially uniform in intensity.

In some aspects, the techniques described herein relate to a module, wherein the forward scatter mask further includes one or more apertures sized and positioned to produce a dual-angle differential scatter Mie map.

In some aspects, the techniques described herein relate to a module, wherein particles in a channel are not confined by sheath fluid, but are free to flow throughout the full cross-sectional area of the channel, and where furthermore, at any point in the full cross-sectional area, they will pass through a laser beam with substantially uniform intensity.

In some aspects, the techniques described herein relate to a module, wherein the one or more focusing optics is configured to provide a beam from the collimated laser on the forward scatter mask having a spatial extent such that the beam substantially avoids one or more forward scatter mask apertures.

In some aspects, the techniques described herein relate to a module, wherein the module also includes an aperture stop and the aperture stop is selected so as to limit a spatial extent of a focused beam on the forward scatter mask, and thereby substantially avoid one or more forward scatter mask apertures.

In some aspects, the techniques described herein relate to a module, wherein the aperture stop is asymmetric and is shaped so as to limit the spatial extent of the focused beam on the forward scatter mask, and thereby substantially avoid one or more forward scatter mask apertures, while maintaining as much power in the beam as possible.

In some aspects, the techniques described herein relate to a bidirectional cytometry sampling system including: a sample holder; a flowcell connected to the sample holder; a gantry robot including a pipettor configured to pipette a fluid sample into the sample holder; and a pump system configured to pump one or more fluids in one or more directions through the flowcell; wherein the flowcell is fluidically connected to the sample holder and the pump system.

In some aspects, the techniques described herein relate to a bidirectional cytometry sampling system, wherein the sample holder further includes: a sample holding cup; a T-junction fluidically connected to the sample holding cup; a waste channel fluidically connected to the T-junction; a valve fluidically connected to the waste channel; a port fluidically connected to the valve; an entry channel fluidically connected to the T-junction; a fluidic fitting fluidically connected to the entry channel; and a fluid conduit fluidically connected to the fluidic fitting and the flowcell.

In some aspects, the techniques described herein relate to a bidirectional cytometry sampling system, wherein the pump system further includes: a selector valve fluidically connected to a sample loop, wherein the sample loop is fluidically connected to the flowcell; a cleaning pump fluidically connected to the selector valve; and a pump fluidically connected to the selector valve and a system fluid; wherein the pump is a high-precision pump, a syringe pump, or a piston pump.

In some aspects, the techniques described herein relate to a bidirectional cytometry sampling system, wherein the bidirectional cytometry sampling system further includes: a sample loop for a sample which is fluidically connected to the flowcell and the pump system.

In some aspects, the techniques described herein relate to a bidirectional cytometry sampling system, wherein the sample holder further includes: a sample cup; a sample tube fluidically connected from the flowcell to the sample cup; and a waste port fluidically connected to the sample cup, wherein the pump system is configured to pump a fluid through the flowcell to the sample cup to clean the flowcell and sample cup.

In some aspects, the techniques described herein relate to a bidirectional cytometry sampling system, wherein the sample holder further includes a sample cup, wherein the sample cup is configured to enable one or more samples to be loaded into the flowcell with an air gap of known size separating a sample from a fluid of a hydraulic system fluidically connected to the flowcell.

In some aspects, the techniques described herein relate to a bidirectional cytometry sampling system, wherein the sample holder further includes a sample cup, wherein the sample cup is configured to collect a used sample and a used cleaning fluid after a run of the bidirectional cytometry sampling system.

In some aspects, the techniques described herein relate to a bidirectional cytometry sampling system, wherein the sample holder further includes a sample cup, wherein the sample cup is configured to automatically direct a used sample and a used cleaning fluid to a waste and clean the sample cup.

In some aspects, the techniques described herein relate to a modular sheathless flow-cytometry system including: a sample holder; a pipettor configured to pipette a fluid sample into the sample holder; a pump system configured to pump one or more fluids in one or more directions through a flowcell; the flowcell fluidically connected to the sample holder and the pump system; one or more focusing optics; a collimated laser configured to shine a beam of light through the one or more focusing optics onto the flowcell; at least one side scatter detector, wherein the at least one side scatter detector is configured to receive light scattered by one or more particles flowing in the flowcell; at least one forward scatter detector, wherein the at least one forward scatter detector is configured to receive the light scattered by one or more particles flowing in the flowcell; a forward-scatter mask with one or more forward-scatter mask apertures to limit a collection of forward scattered light to a set of defined scatter angles; and a processor configured to capture data received by the at least one side scatter detector and the data received by the at least one forward scatter detector to determine at least one characteristic of the one or more particles received by the flowcell.

In some aspects, the techniques described herein relate to a modular sheathless flow-cytometry system, wherein the flowcell further includes thicker walls configured to shift one or more contaminating particles away from a beam on the flowcell.

In some aspects, the techniques described herein relate to a modular sheathless flow-cytometry system, wherein the flowcell further includes an enclosure surrounding the flowcell configured to shift one or more contaminating particles away from a beam on the flowcell.

In some aspects, the techniques described herein relate to a modular sheathless flow-cytometry system, further including a side-scatter optical path, the side-scatter optical path including: one or more filters; an automated system for inserting and removing the one or more filters; and a controller configured to operate the automated system.

In some aspects, the techniques described herein relate to a modular sheathless flow-cytometry system, wherein the pump system is configured to flow a sample within the flowcell with bidirectional flow, wherein the pump system is further configured to flow a sample fluid one or more times in the flowcell, and wherein with each flow of the sample fluid through the flowcell one or more measurements on the at least one forward scatter detector is made.

In some aspects, the techniques described herein relate to a modular sheathless flow-cytometry system wherein during each pass of the fluid sample through the flowcell, a configuration of the modular sheathless flow-cytometry sampling system may be changed in an automated way, such as by increasing or decreasing laser power, increasing or decreasing flow rate through the flowcell, or inserting or removing filters from a side optics channel, so that each pass through the flowcell may result in collection of one or more datasets representing different characteristics of the one or more particles flowed through the flowcell.

In some aspects, the techniques described herein relate to a modular sheathless flow-cytometry system wherein the at least one side scatter detector is positioned at an exit pupil of a side optical train, thereby making it relatively insensitive to changes in a position of the one or more particles within a cross-section of the flowcell.

In some aspects the techniques described herein relates to a modular sheathless flow-cytometry system wherein the oversized astigmatic beam that fills the cross-section of the flow-channel will still fill the cross-section of the flow channel and interact with the particles flowing therein, even if the beam is misaligned with the center of the channel by an amount of up to 400 microns.

In some aspects, the techniques described herein relate to a modular sheathless flow-cytometry system wherein light on the forward scatter mask is deliberately defocused so that a desired amount of DC light enters at least one of the one or more forward-scatter mask apertures, creating coherent interference with light scattered off particles flowing in the flowcell, and which thereby generates asymmetric pulses on one or more forward-scatter channels.

In one aspect, the module comprises a cytometer having a highly-astigmatic beam, wherein the beam is focused at the flowcell channel in a first dimension, while being unfocused at the flowcell channel in a second dimension, such that in the second dimension the beam overfills a cross-section of the flow channel with a substantially uniform intensity of light that extends beyond the walls of the channel; and wherein the beam is at the same time unfocused at the forward-scatter-mask in the first dimension and focused at the forward-scatter-mask in the second dimension, the forward-scatter mask further including mask-apertures that are sized and positioned so as to minimize their interaction with non-scattered light.

One or more embodiments may provide a cytometry module which comprises inserting and removing filters from the side-scatter path in an automated way in response to software commands.

One or more embodiments may provide a sheathless-flow cytometry module which comprises a reusable sample cup that enables a sample to be loaded into a flowcell with a reproducible air-gap of known-size separating the sample from the hydraulic system fluid. The sample cup may also serve as a collection reservoir that collects the used sample and cleaning fluid after the run. The sample cup may be further equipped to automatically direct the used sample and cleaning fluid to waste, and then clean itself, in preparation for the next run.

One or more embodiments may provide a sheathless-flow cytometry module which comprises a flowcell that may be used to interrogate sample with a bidirectional flow. A sample may first be pulled and then optionally pushed through a flowcell, enabling measurements to be taken on the sample while it is being flowed in both directions. Because the flow is sheathless, the sample remains uncontaminated by sheath fluid with each passage though the flowcell. This process may be repeated an arbitrary number of times, and different measurements may be made on the sample with each passage through the flowcell.

One or more embodiments may provide a cytometry module which comprises integrating the cytometry module into a multi-modal instrument such that it can seamlessly utilize shared resources, such as a gantry robot, waste pump, and syringe pump, while at the same time remaining its own modular system.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a block model of the optical path in the cytometer that is the object of this invention, according to one or more embodiments.

FIG. 2 depicts a portion of the optical train that includes the focusing optics (L1 and L2), the flowcell, and the forward-scatter mask, according to one or more embodiments.

FIG. 3A depicts a model of a beam intensity profile at a flowcell in the Y-dimension, according to one or more embodiments.

FIG. 3B depicts a model of a beam intensity profile at a flowcell in the X-dimension, according to one or more embodiments.

FIG. 4A depicts a model of a beam intensity profile at a flowcell in the Y-dimension for a particular set of focal lengths of lenses, an aperture stop size, and a wavelength, according to one or more embodiments.

FIG. 4B depicts a model of a beam intensity profile at a flowcell in the X-dimension for a particular set of focal lengths of lenses, an aperture stop size, and a wavelength, according to one or more embodiments.

FIG. 5 depicts a table of aperture stop sizes, lens focal lengths, and wavelengths, that may produce the optical profiles of FIG. 3A-3B.

FIGS. 6A-6C depict a beam on a forward scatter mask, according to one or more embodiments.

FIG. 6A depicts an elliptical low-power beam on a forward scatter mask with a neutral density (ND) filter limiting the intensity of light, according to one or more embodiments.

FIG. 6B depicts an elliptical low-power beam on a forward scatter mask without a neutral density filter, according to one or more embodiments.

FIG. 6C depicts an elliptical beam on a forward scatter mask at a laser power of 75 mW, according to one or more embodiments.

FIG. 7A depicts radially-symmetric aperture stops of different diameters that may be positioned in a collimated beam between mirrors, and the resulting focused beam profile on the forward scatter mask according to one or more embodiments.

FIG. 7B depicts the power of un-scattered light on first and second forward scatter detectors as a function of aperture stop diameter, according to one or more embodiments.

FIG. 7C depicts radially asymmetric aperture stops, and the beam profiles at the forward scatter mask for each one, according to one or more embodiments.

FIG. 7D depicts a radially symmetric aperture stop, the corresponding beam at the forward scatter mask, and the forward-scatter amplitudes that result from scattering off beads flowed in this configuration, according to one or more embodiments.

FIG. 7E depicts a radially asymmetric aperture stop, the corresponding beam at the forward scatter mask, and the forward-scatter amplitudes that result from scattering off beads flowed in this configuration, according to one or more embodiments.

FIG. 8 depicts graphs of digitized-detector-voltage measured at a first forward scatter detector versus time for light scattered off particles flowing in a flowcell when the laser beam is limited by two different radially-symmetric aperture stops, according to one or more embodiments.

FIG. 9A depicts graphs of digitized detector voltage measured at a first forward scatter detector versus digitized detector voltage measured at a second forward scatter detector for light scattered from particles flowed through a flowcell when the laser beam is limited by radially symmetric aperture stops of different diameters, according to one or more embodiments.

FIG. 9B depicts the forward scatter detector percent coefficient of variation (% CV) in the light intensity measured at forward scatter detector one as a function of the system aperture stop diameter from light-scattering events off 4-μm diameter round particles, according to one or more embodiments.

FIG. 10 depicts forward scatter detector percent coefficient of variation (% CV) in the light intensity measured at forward-scatter-detector-one as a function of aperture stop diameter for 2-μm diameter round particles, according to one or more embodiments.

FIG. 11A depicts a microscope image of a square fluidic channel including a manufacturing defect on the wall of the channel, according to one or more embodiments.

FIG. 11B depicts interference from particles that flow near a defect, according to one or more embodiments.

FIG. 11C depicts broadened population clusters, according to one or more embodiments.

FIG. 11D depicts a graph of more uniform pulses, according to one or more embodiments.

FIG. 11E depicts a graph of less broadened population clusters, according to one or more embodiments.

FIG. 12A depicts a flowcell with thin walls, according to one or more embodiments.

FIG. 12B depicts a flowcell with thicker walls, according to one or more embodiments.

FIG. 12C depicts a flowcell with secondary packaging and thin walls, according to one or more embodiments.

FIG. 13 depicts, according to one or more embodiments, when a beam is defocused on the forward scatter mask such that un-scattered light enters one or more of the forward-scatter-mask apertures, an asymmetric pulse shape may result from a simple spherical particle, according to one or more embodiments, when the beam is focused, a more symmetric pulse may be observed, according to one or more embodiments, and when the beam is defocused again, and the flow may be reversed in the flowcell, a different sort of asymmetry may be observed, according to one or more embodiments.

FIG. 14A depicts, according to one or more embodiments, flow in a first direction results in the asymmetric pulse shape shown, including the pulse measured by forward-scatter-detector one (FSC1) which may exhibit a peak followed by a trough, and forward-scatter-detector two (FSC2) which may have a single peak with a shallower slope on the leading edge.

FIG. 14B depicts, according to one or more embodiments, reversing the direction of flow, resulting in reversal of the asymmetric pulses so that the FSC2 pulse may have a trough followed by a peak, and FSC1 which may have a steeper slope on the leading edge.

FIG. 15 depicts a bidirectional cytometry sampling system, according to one or more embodiments.

FIG. 16 depicts a reusable sample holder, according to one or more embodiments.

FIG. 17A-17I depicts steps involved in bidirectional sample analysis using the sheathless flow cytometry system, according to one or more embodiments.

FIG. 18A depicts a view of a cytometer including motorized cams interacting with two filter-sliders, according to one or more embodiments.

FIG. 18B depicts an internal view of the side-scatter optical path, illustrating the position of the filter-sliders with respect to the optical path, according to one or more embodiments.

FIG. 19 depicts a cytometry sampling system using a simplified sample holder, according to one or more embodiments.

FIGS. 20A-20E depict views of flowcells, according to one or more embodiments.

FIG. 20A depicts a block flowcell in a side view, according to one or more embodiments.

FIG. 20B depicts a block flowcell in a top view, according to one or more embodiments.

FIG. 20C depicts a block flowcell in an isometric view, according to one or more embodiments.

FIG. 20D depicts a capillary flowcell in a perspective view, according to one or more embodiments.

FIG. 20E depicts a capillary flowcell in a top view, according to one or more embodiments.

FIG. 21A depicts an isometric view of a stir-pipettor, according to one or more embodiments.

FIG. 21B depicts a bottom view of a stir-pipettor with a zoomed-in view of the pipette as it turns, and describes a circular arc, according to one or more embodiments.

FIG. 22 shows an exemplary waste/wash station of the fluidic system of the present disclosure, according to one or more embodiments.

FIG. 23 depicts an exemplary fluid architecture of the system of the present disclosure, according to one or more embodiments.

FIG. 24A depicts a reagent consumable plate including a cartridge that resembles a well-plate, according to one or more embodiments.

FIG. 24B depicts consumables used by the analytical module, which include a strip of reaction vessels, and a strip of reagent vessels, according to one or more embodiments.

FIG. 25A-25B depicts the laser beam on the flowcell and the forward-scatter-mask, along with the scattergram that results from flowing 2, 4, and 6 um diameter beads through the flowcell under these conditions for an aligned state and a misaligned state, according to one or more embodiments.

FIG. 25A depicts a properly aligned laser beam on the flowcell channel and the forward-scatter-mask, along with the scattergram that results from flowing 2, 4, and 6 um diameter beads through the flowcell under these conditions, according to one or more embodiments.

FIG. 25B depicts a badly misaligned laser beam on the flowcell channel and the forward-scatter-mask, along with the scattergram that results from flowing 2, 4, and 6 um diameter beads through the flowcell under these conditions, according to one or more embodiments.

FIG. 26A-26C depicts an exemplary side-optics configuration, with ray-traces and spot diagrams, illustrating how the side optics train may image the exit pupil of the system instead of the object and is therefore insensitive to offsets of particles in the flowcell, according to one or more embodiments.

FIG. 26A depicts an exemplary side-optics configuration and ray-traces representing light coming from an object that is displaced away from the collection lens, at a nominal position relative to the collection lens, and closer to the collection lens, according to one or more embodiments.

FIG. 26B depicts a spot diagram at the expected object image plane, according to one or more embodiments.

FIG. 26C depicts a spot diagram at the exit pupil plane, according to one or more embodiments.

### DETAILED DESCRIPTION

There is a need to create a sheathless flow cytometer that maintains the precision and accuracy of traditional clinical flow cytometers by utilizing an optical beam large enough that it can detect and count all the cells passing through the flowcell, using a relatively simple, low-cost optical train. Additionally, there is a need to provide the cytometer with means of inserting and removing filters from the side-scatter optical path in an automated way, so that multiple parameters, such as fluorescence and polarization can be interrogated using a single side-scatter detector. Additionally, there is a need to provide a reusable sample-cup that enables the flowcell to be loaded with a sample and cleaned in an automated fashion so that no user intervention is required before the next sample is run. Lastly, there is a need to demonstrate a cytometer that delivers clinical-quality results in a low-cost embodiment. One or more embodiments are directed to overcoming one or more of these challenges.

One or more embodiments may provide a system including a flow cytometry module and related hardware for performing hematology measurements. One or more embodiments may provide a system including a modular, sheathless flow cytometer and associated hardware. One or more embodiments may provide a module comprising a cytometer having a highly-astigmatic beam, wherein one dimension of the beam is focused at the flowcell channel, and the other dimension of the beam is focused at the forward-scatter-mask, the forward-scatter mask further including mask-apertures that are sized and positioned so as to minimize their interaction with non-scattered light. One or more embodiments may include a forward-scatter mask with one or more forward scatter mask apertures to limit a collection of forward scattered light to a set of defined scatter angles.

One or more embodiments may provide a module comprising a cytometer having a highly-astigmatic beam, wherein one dimension of the beam overfills the flowcell channel, extending beyond the walls of the channel, such that the entire cross-section of the flow channel is illuminated by light having a substantially uniform intensity.

One or more embodiments may provide the cytometry module comprising a system for inserting and removing filters from the side-scatter path in an automated way in response to software commands. One or more embodiments may provide the cytometry module comprising a reusable sample cup that enables a sample to be loaded into a flowcell with a reproducible air-gap of known-size separating the sample from the hydraulic system fluid. The sample cup also may serve as a collection reservoir that collects the used sample and cleaning fluid after the run. The sample cup may further be equipped to automatically direct the used sample and cleaning fluid to waste, and then clean itself, in preparation for the next run.

One or more embodiments may provide the cytometry module comprising a flowcell that may be used to interrogate sample with a bidirectional flow. A sample may first be pulled and then pushed through a flowcell, enabling measurements to be taken on the sample while it is being flowed in both directions. Because the flow is sheathless, the sample may remain uncontaminated by sheath fluid with each passage though the flowcell. This process may be repeated an arbitrary number of times, and different measurements may be made on the sample with each passage through the flowcell.

One or more embodiments may provide the cytometry module integrated into a multi-modal instrument such that it may seamlessly utilize shared resources, such as a gantry robot, waste pump, and syringe pump, while at the same time remaining its own modular system.

### Flowcell

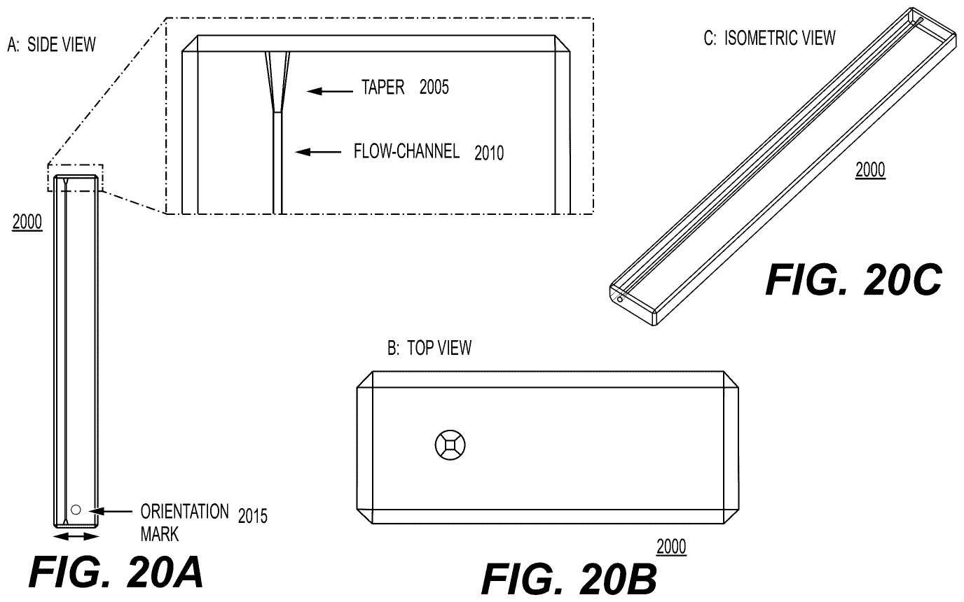

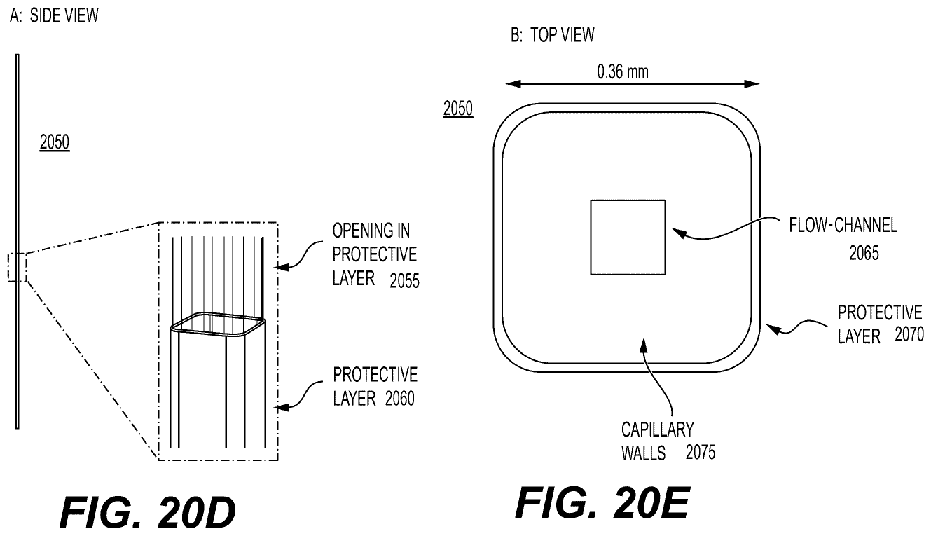

An aspect of the flow cytometer of the present disclosure includes a flowcell. One or more embodiments may provide a flowcell channel. An example of a flowcell used in the flow cytometer module of the present disclosure is illustrated in FIG. 20A-20E. One or more embodiments may provide a block flowcell. One or more embodiments may provide a capillary. These two types of flowcell are shown in FIG. 20A-20E. One or more embodiments may provide, the flowcells are made of fused silica. One or more embodiments may provide the flowcells are made of a plastic having low autofluorescence and low birefringence, such as cyclic-olefin-polymer or cyclic-olefin-copolymer. One or more embodiments may provide a flowcell for use with sheathless flow.

### Optical Train

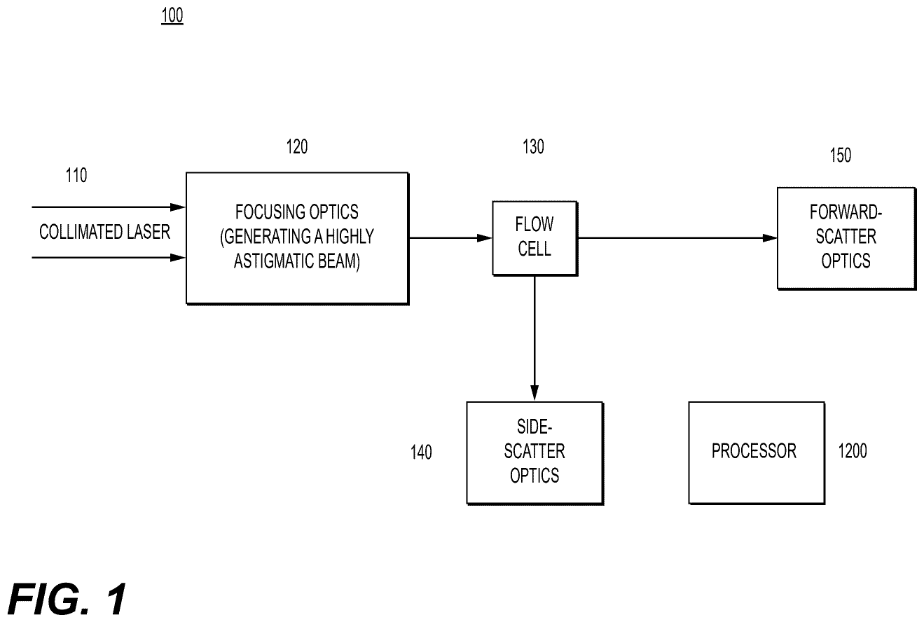

One or more embodiments may provide a cytometry module which comprises an optical train. The optical train enables the full flowcell channel to be interrogated with minimal light-intensity variation, while minimizing the DC (unscattered) light received by the forward-scatter detectors. A block model of the optical path may be seen, for example, in FIG. 1.

One or more embodiments may provide a cytometry module which comprises a collimated laser beam. One or more embodiments may provide a cytometry module which comprises focusing optics. The cytometry module may provide that the collimated laser is configured to shine through the focusing optics. One or more embodiments may provide a cytometry module which comprises a light emitter and light detector. One or more embodiments may provide a cytometry module which comprises at least one forward-scatter detector. One or more embodiments may provide a cytometry module which comprises at least one side-scatter detector. One or more embodiments may provide a cytometry module which comprises forward optics. One or more embodiments may provide a cytometry module that comprises a collimated laser beam directed through focusing optics that generates a highly astigmatic beam. The beam then passes through a flowcell, where it interacts with particles in the flowcell channel. The resultant scattered light may be transmitted to the forward-scatter and side-scatter optics.

One or more embodiments may provide a cytometry module which comprises a first focusing lens. One or more embodiments may provide a cytometry module which comprises a second focusing lens. One or more embodiments may provide a cytometry module which comprises a cylindrical lens. One or more embodiments may provide the cylindrical lens is an asymmetric diverging lens.

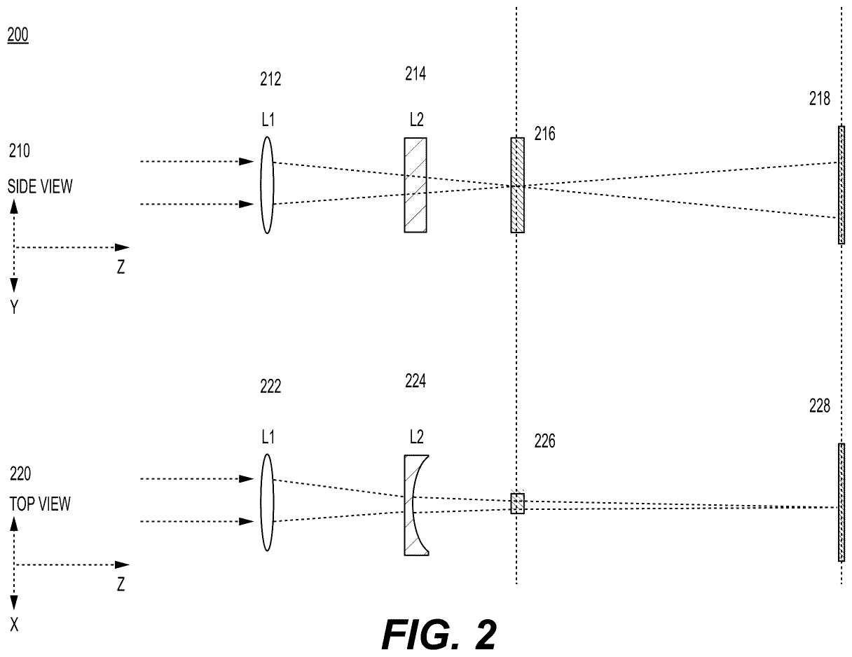

FIG. 2 depicts details of an embodiment of the focusing optics, flowcell, and forward optics. As shown in the figure, the focusing optics include a first focusing lens, L1, and a second cylindrical lens, L2. Lens L1 may act on the collimated laser to focus the beam down to a narrow spot on the flowcell. In the absence of lens L2, the beam would be symmetrically focused to a round spot much smaller than the channel diameter.

However, the cylindrical lens L2 is an asymmetric diverging lens: In the Y-dimension, L2 may have no impact on the optical beam; the light rays may continue to converge to a focused point at the flowcell. But in the X-dimension, the beam convergence may be reduced. In this dimension, the beam may not become focused until it reaches the forward scatter mask. Thus, at the flowcell, the beam is an elongated ellipse with the long axis perpendicular to the flow channel and extending over the full cross-section of the channel.

One or more embodiments may provide a cytometry module which comprises a forward scatter mask. An equally important focusing event occurs at the forward scatter mask, but in the perpendicular direction. Here, the beam is focused in the X dimension, but has become elongated in the Y dimension. Thus, at the forward scatter mask, the beam is an elongated ellipse, perpendicular to the ellipse at the flowcell.

One or more embodiments may include a forward-scatter mask having mask-apertures such that when the beam is properly focused, the ellipse of light is fully-contained between the mask-apertures, and diffracted light substantially misses the mask-apertures, such that the majority of light that enters the mask-apertures is that scattered off particles in the flowcell.

One or more embodiments may include the forward-scatter mask when the beam is defocused. In this case, non-scattered light on the forward-scatter mask may partially overlap the forward-scatter-mask apertures. Light received by the forward-scatter detectors may be a mixture of scattered light and DC light. Due to the coherent nature of the laser light, this may result in intensity and pulse-shape variations.

One or more embodiments may provide the cytometry module is used with a beam that is focused in the X-axis on the forward scatter mask, so that non-scattered light is reducibly collected by the forward-scatter detectors. One or more embodiments may provide a method for achieving this state is to first adjust the focusing lens, L1, until the light is focused in the X-dimension on the forward-scatter-mask. One or more embodiments may provide this may be done through active monitoring of the DC-level of the photodiodes behind the forward-scatter-apertures when no sample is flowing in the flowcell. When the amount of DC light is reduced at the photodiodes, the proper focus may have been achieved at the forward-scatter-mask. If the focusing lenses are well-aligned, this action may also properly focus the Y-dimension of the beam at the flowcell. It is a feature of this optical design that the beam may be somewhat defocused at the flowcell without impacting the ability of the cytometer to observe passing particles. A slightly defocused beam at the flowcell may result in a slightly larger beam diameter at the flowcell, reducing the amount of light available for collection. However, this slight loss of intensity can be compensated for by increasing the power of the laser.

One or more embodiments may provide an additional degree of freedom which may be provided so that a focus can be achieved at both the flowcell and the forward-scatter-mask. For example, either the flowcell, or the forward-scatter-optical assembly may be capable of small translations in the Z-axis (parallel to beam propagation). Alternatively, or in addition, the distance between lenses L1 and L2 may be adjustable.

There may be additional sources of optical noise that may impact the results. For example, as the light travels through the flowcell, it may interact not only with the particles flowing in the channel, but also with the edges of the channel itself, resulting in a diffraction pattern that may be seen on the forward scatter mask. To achieve the desired goal of measuring only the scattered light at the forward-scatter photodiodes, this diffraction pattern may be substantially avoided.

One or more embodiments may provide the forward-scatter apertures are sized and positioned so that they substantially avoid both the focused beam and the diffraction pattern on the mask.

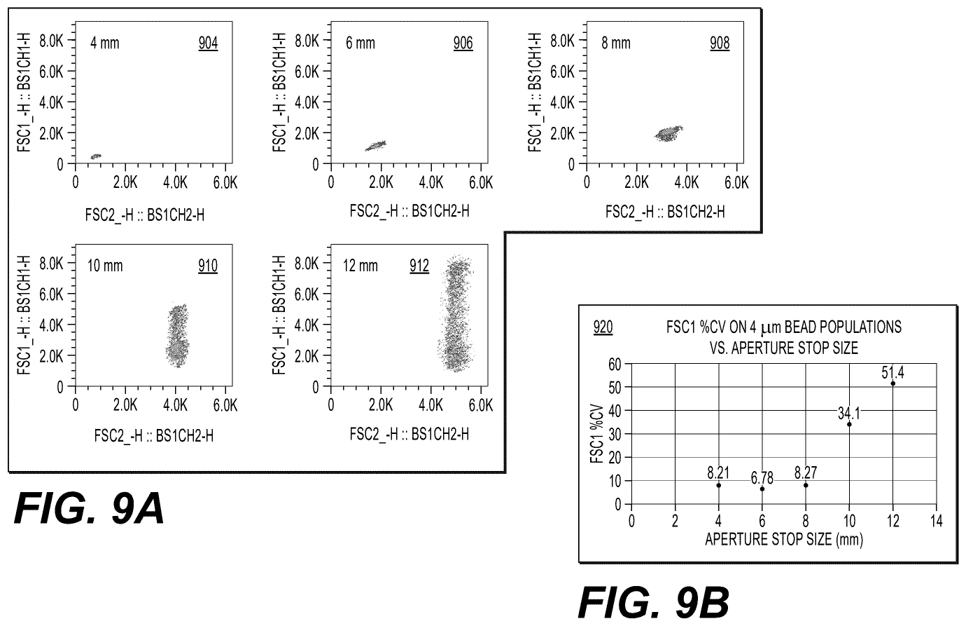

One or more embodiments may provide it may not be possible to completely avoid both the focused beam and the diffracted light. Thus, one or more embodiments may provide the intensity of the undesired light on the forward scatter mask can be reduced through use of masks or beam-blocks located between the flowcell and the forward-scatter-mask that prevent any unnecessary light from propagating. Thus, one or more embodiments may provide the cytometry module comprises one or more masks. One or more embodiments may provide the intensity of the undesired light on the forward scatter mask may be reduced through use of an aperture stop, such as those shown in FIG. 9A. In some embodiments the aperture stop may be radially symmetric. In some embodiments the aperture stop may be asymmetric, so as to preferentially alter the shape of the focused beam on the forward scatter mask and thereby reduce the amount of DC light entering the forward-scatter-mask apertures.

One or more embodiments may provide the cytometry module comprises a system including a highly-asymmetric beam generated by the focusing optics, so that the beam is focused in one dimension on the plane of the flowcell channel, and in the other dimension on the plane of the forward-scatter-mask. One or more embodiments may provide at the flowcell, the width of the beam of light is wide enough that it spans the entire cross-sectional area of the flowcell channel with minimal variation in light intensity, thus enabling the cytometer to detect identical or near-identical particles with approximately equal scatter intensity, independent of where they are located in the channel cross-section. One or more embodiments may provide the cytometry module comprises a system for masking unnecessary light at the flowcell to reduce the intensity of non-scattered light propagating in the forward direction. One or more embodiments may provide the cytometry module comprises apertures on the forward scatter mask configured to be sized and located so that they are minimally impacted by un-scattered light when the beam is focused at the forward-scatter-mask.

The focusing optics may be used to generate the astigmatic beam as depicted for example in FIG. 2. The focusing optics may consist of a symmetric lens and a cylindrical lens. However, there may be other ways to create such a beam using other beam shaping optical elements, such as anamorphic prisms, diffractive light shaping elements, and asymmetric pupil masks. These elements may achieve the same effect and may be used in in one or more embodiments. One or more embodiments may provide a method of creating uniform excitation at the flowcell but still separating scattered vs. non-scattered light with sufficient isolation at the forward-scatter-mask apertures when analyzing a sample.

### Deliberate Defocusing and Interrogation of Pulse-Shape

One or more embodiments may provide the cytometer is used so that the astigmatic beam is focused in the X-dimension on the forward-scatter mask so that a minimum or reduced amount of non-scattered light is incident on the forward-scatter-apertures. However, one or more embodiments may provide the cytometry module may be used so that the beam is deliberately defocused in the X-dimension on the forward-scatter mask so that non-scattered light does enter one or more of the forward-scatter-apertures.

The interaction of coherent scattered and non-scattered light may lead to temporal and spatial intensity changes in the light detected at the forward-scatter photodetectors, which may result in asymmetric pulse shapes being generated by simple particles. These variations in pulse-shape may provide additional information about the size and shape of the particles being measured.

One or more embodiments may provide the cytometry module of the present disclosure may include single or multiple-pass systems in which particles are flowed through the flow-channel and can be passed through the system again.

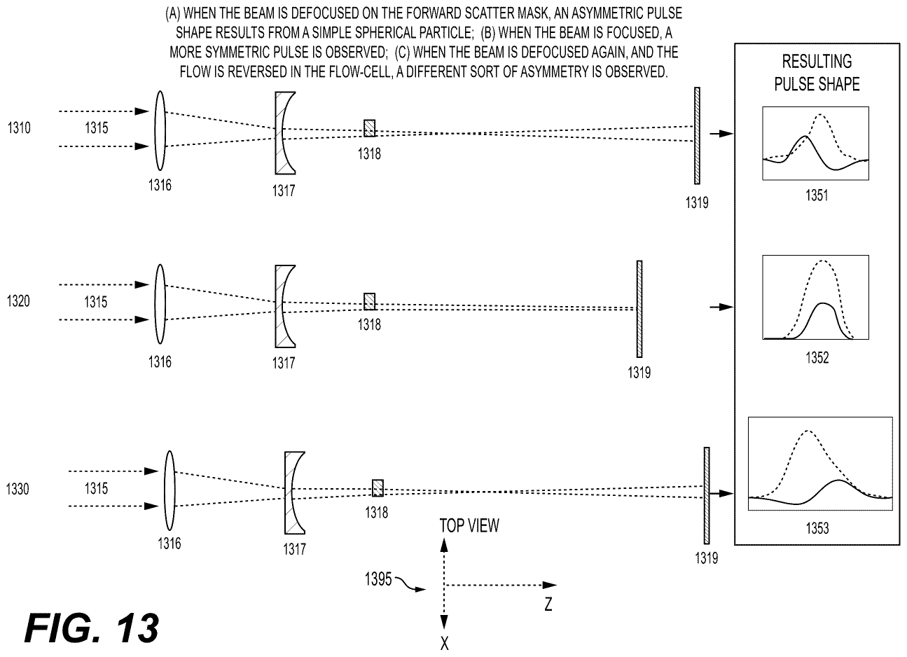

The cytometry module of the present disclosure may be sheathless and may enable bidirectional flow, thus the flow of particles may be observed in the flowcell in both directions, thereby generating pulse-shapes that provide an additional set of data for each test. Furthermore, as described herein, one or more embodiments may provide the forward-scatter-mask or the flowcell may be translated in the Z-axis parallel to the beam. This translation, coupled with the ability to flow the same sample through the same flowcell multiple times, may enable the cytometry module system to interrogate the beam when it is focusing at different planes, and may result in different amounts of interference. These aspects of the cytometry module may be depicted for example in FIG. 13.

As shown in FIG. 13, when the beam is defocused on the forward scatter mask, an asymmetric pulse shape may result from scatter off a simple spherical particle. When the beam is focused, a more symmetric pulse may be observed, and when the beam is defocused again and the flow is reversed in the flowcell, a different asymmetry may be observed. The focusing and defocusing of the beam may be achieved through mechanical translation of the forward-scatter mask (for example, by adjusting the position of the mask depicted in FIG. 13). However, the focus of the beam may also be adjusted optically.

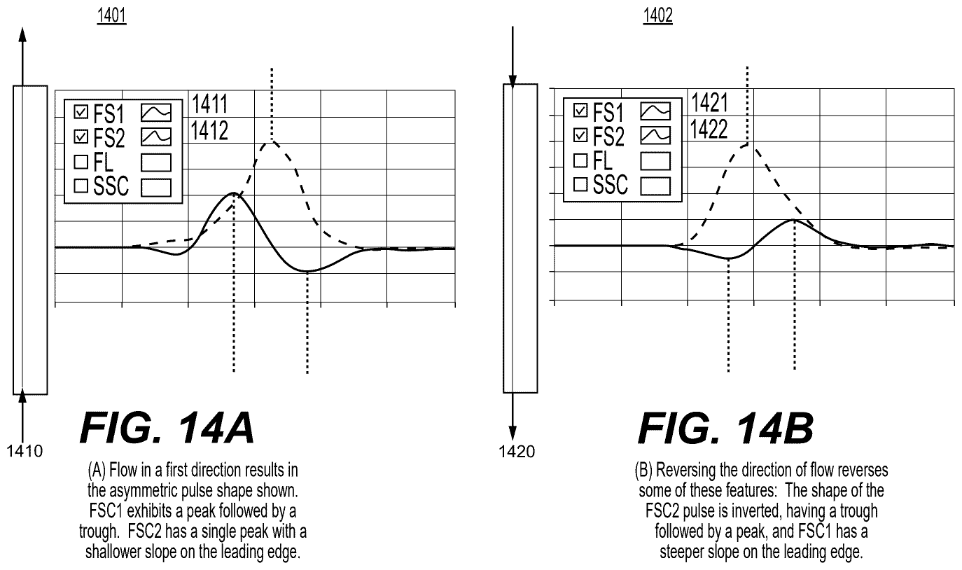

FIG. 14A-14B depict data acquired during forward and reverse-flows through the flowcell in the cytometry module system when the beam is slightly defocused on the forward-scatter-mask. Certain features of the FSC1 and FSC2 pulses may be inverted. The information contained within these asymmetric pulses may be used in discerning cell types.

### Sample Cup, and Bidirectional Flow

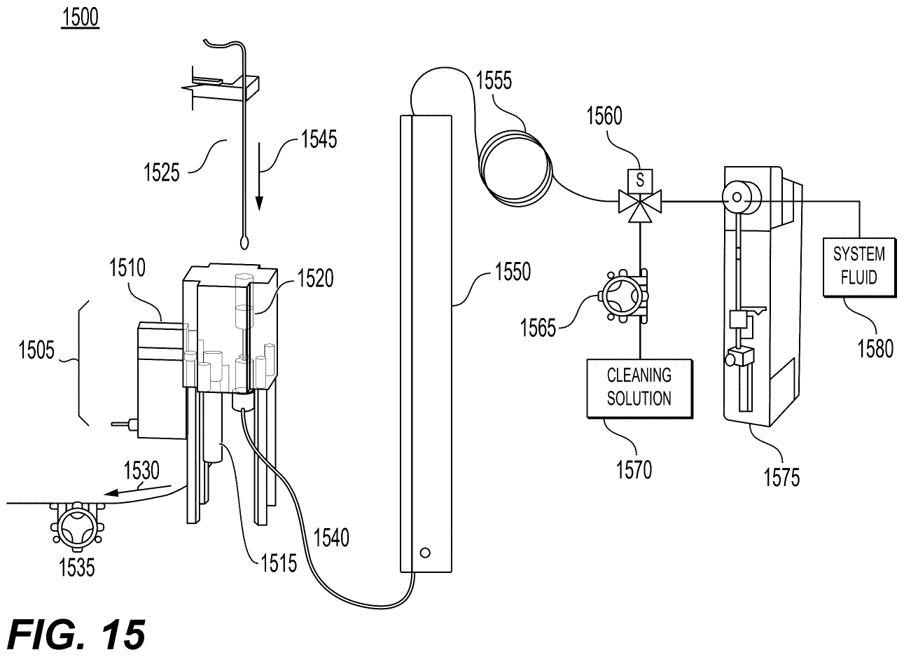

One or more embodiments may provide the cytometry module of the present disclosure comprises a reusable sample cup. As depicted for example in FIG. 15, one or more embodiments may provide a reusable sample cup connected by a tube to one end of the flowcell. One or more embodiments may provide the other end of the flowcell is connected to a length of tubing that serves as a sample loop. One or more embodiments may provide the other end of the flowcell is connected to a length of fluid conduit that serves as a sample loop. The sample loop has a volume large enough to hold the volume of the aspirated sample, and may have an inner diameter (ID) big enough that it does not appreciably contribute to pressure drop during flow. For example, the sample loop may be an FEP tube having an ID of 0.030″ (762 um). Alternatively, the sample loop may also be a PEEK tube having an ID of 0.015″ (381 um). The other end of the sample loop may be connected to a 3-way switching valve that can switch between a high-precision pump filled with system fluid, and a low-cost cleaning pump. The high precision pump may be a piston pump or syringe pump. The low-cost cleaning pump may be a membrane pump or peristaltic pump.

As depicted for example in FIG. 15, the reusable sample holder may have a sample cup configured to hold the sample of interest. The sample cup may be fluidically connected through the entry channel to tubing that leads to the flowcell. The sample cup may be further connected to a waste channel through a normally-closed valve. The waste channel and entry channel may meet at a T-junction just below the sample cup.

### Methods of Operating and Analyzing a Sample Using the Cytometry Module

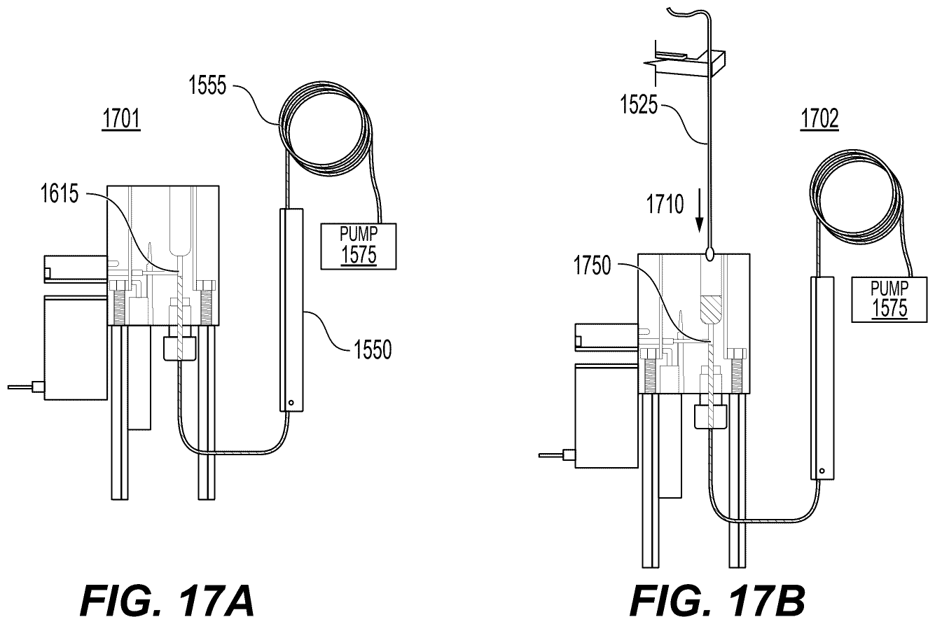

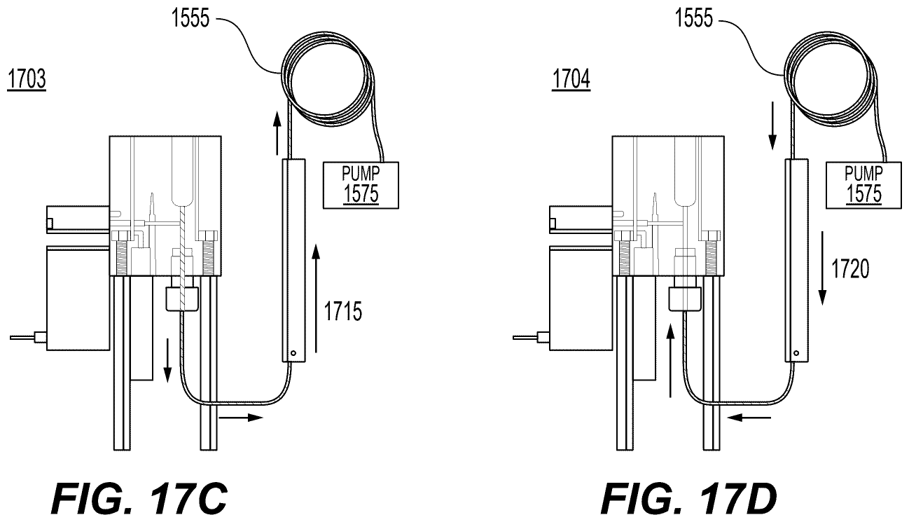

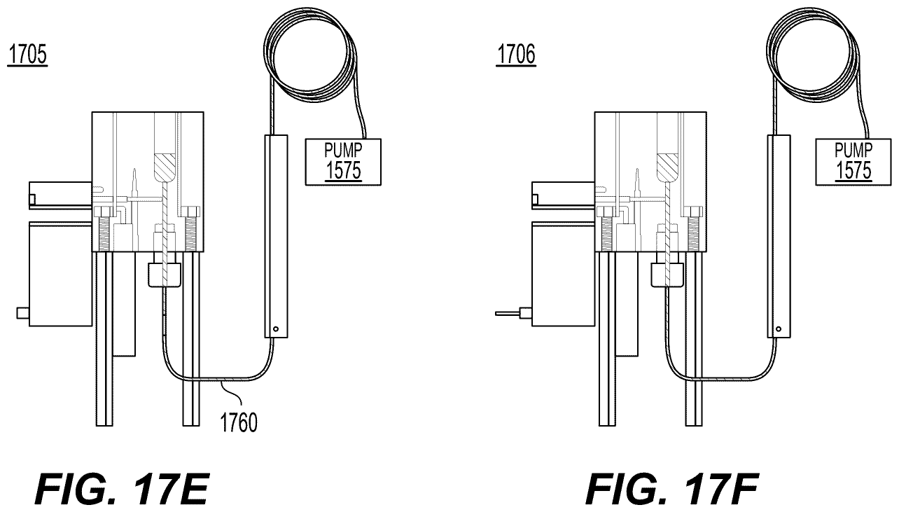

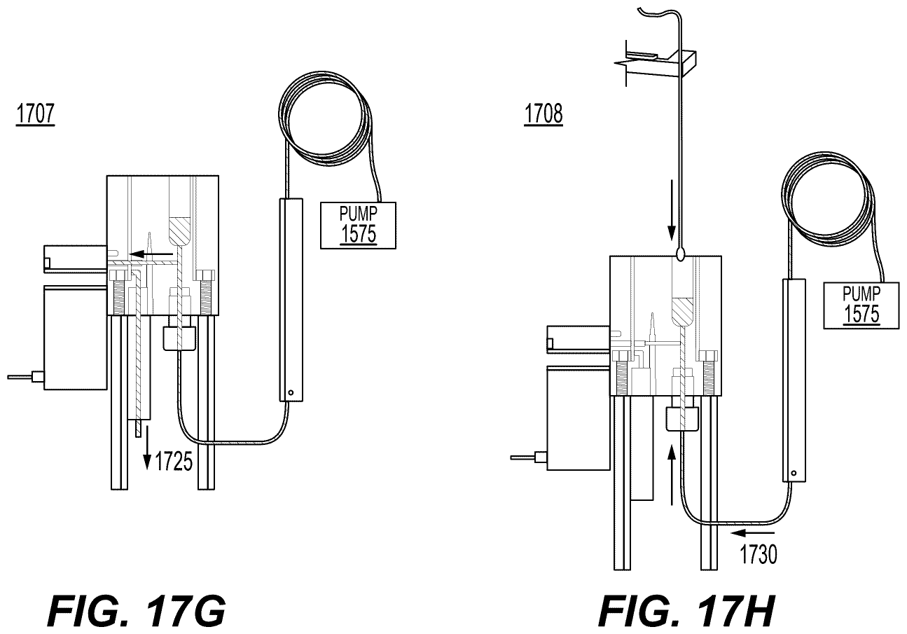

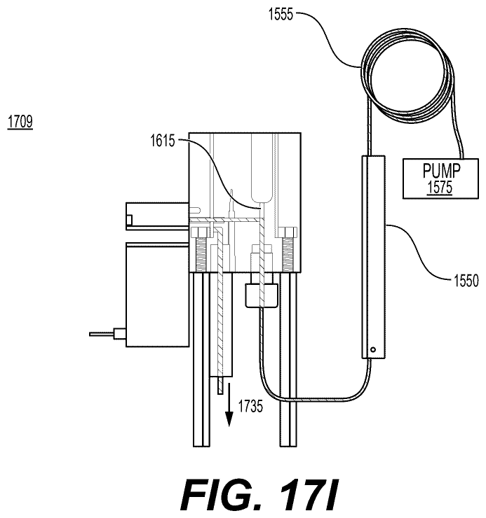

One or more embodiments may provide operation of the cytometry system as described below. For example, one or more embodiments may provide methods including one or more of the steps as recited below (see also, for example, FIG. 17A-17I).

(A) One or more embodiments may provide in the initial state, the sample loop, flowcell, and tubing are filled with system fluid, and the sample holding cup is empty and clean.

(B) One or more embodiments may provide the pipettor dispenses a sample of whole blood into the sample-holding cup.

(C) One or more embodiments may provide the high-precision pump aspirates the sample through the flowcell into the sample loop at the desired flow rate, Q1, while sample measurements are made with the laser having intensity 11, and the filters in state #1.

(D) One or more embodiments may provide after measurements are finished, the high-precision pump optionally reverses direction and pushes the sample back through the flowcell. The flow rate, laser power, and filter-states may be kept the same, or may be changed, depending on the desire of the user. More measurements may be made during this push-step.

(E) Steps (C) and (D) may be repeated as desired, with the sample being first pulled and then pushed through the flowcell by the high precision pump. During each pass through the flowcell new measurement parameters may be used. For example, the laser power can be turned up or down, the flow rate can be increased or decreased, and filters may be inserted or removed from the optical path.

(F) One or more embodiments may provide after all measurements are completed the pump pushes the entire sample back into the sample-holding cup.

(G) One or more embodiments may provide the normally-closed waste valve is then opened, and the waste pump (not shown) is used to pull fluid from the holding cup through the waste channel to waste.

(H) & (I) One or more embodiments may provide the fluid path, including the sample loop, flowcell and holding cup are now cleaned.

If a specialized cleaning fluid is used, a selector valve as described herein may be switched so that the fluid path is open to a cleaning pump. The cleaning pump then may push the cleaning fluid through the sample loop and flowcell to the holding cup. Then the waste valve may be opened, and the holding cup is drained through the waste channel.

After the sample cup is sufficiently cleaned, the selector valve is switched back so that the fluid path may be connected to the precision system-fluid pump. System fluid may then pushed through the sample loop, and flowcell to the holding cup. Again, then the waste valve may be opened, and the holding cup may be drained through the waste channel.

As a final cleaning step, the pipettor may be used to dispense additional system fluid into the holding cup. Afterwards, once again, the waste valve may be opened, and the holding cup may be drained through the waste channel.

One or more embodiments may provide that it may be unnecessary to flow a specialized cleaning fluid through the flowcell. Rather, it may be sufficient to flush the sample loop and flowcell with system fluid. In these embodiments, the selector valve, cleaning pump, and cleaning fluid reservoir as described herein may not be required.

The cytometry module of the present disclosure may comprise a reusable sample cup, and the sample may be both pulled and pushed through the flowcell, to and from the sample cup.

The cytometry module of the present disclosure may enable the same sample to be interrogated multiple times in the flowcell as it is being aspirated and dispensed through it. For example, relative to unidirectional flow, half the volume of sample may be interrogated to provide the same number of events (cell counts).

Interrogation of the same sample using the same conditions may provide a check on the data, the cell counts measured during the dispense operation may closely match those obtained during the aspiration operation.

The parameters (flow rate, laser power, filter states) during the aspirate operation may not need to be the same as the parameters during the dispense operation. For example, the flow rate, laser power, or filter states during aspiration may be optimized for detection of one population of cells, while the flow rate, laser power, or filter states during the dispense operation may be optimized for detection of a different population of cells. The combined data set (from pull and push operations) may therefore provide a more complete and accurate picture of the cell count than unidirectional operation could.

One or more embodiments may provide an architecture including a durable (re-usable) sample cup to hold sample, thereby reducing consumable waste.

One or more embodiments may include an architecture which uses a sample loop, thus preventing the pump and valve from being contaminated by sample. One or more embodiments may provide that the pump and valve do not require cleaning.

Aspects of the present disclosure may include methods for analyzing one or more cells in a sample using the cytometry module of the present disclosure.

### Automated Filter Insertion and Removal

The measurement parameters with which the sample is interrogated may be changed with each pass through the flowcell. For example, the laser power may be turned up or down and the flow rate may be increased or decreased.

One or more embodiments may provide filters that may be inserted or removed from the optical path using an automated system or a robotic system according to the one or more embodiments. One or more embodiments may provide motorized filter-sliders or filter-wheels in a flow-cytometer. Some existing flow cytometers may only pass the sample through the flowcell once. In some systems all desired data must be gathered during this single pass of the sample through the flowcell thus requiring parallel detectors. For example, some cytometers use sheath fluid, and the sheath fluid mixes with the sample after a first pass through the flowcell, so it is not possible to interrogate the sample multiple times. One or more embodiments of the sheathless-flow cytometer described herein permit the sample to be pushed and pulled through the flowcell multiple times, and with each pass different filters may be automatically inserted or removed from the optical path.

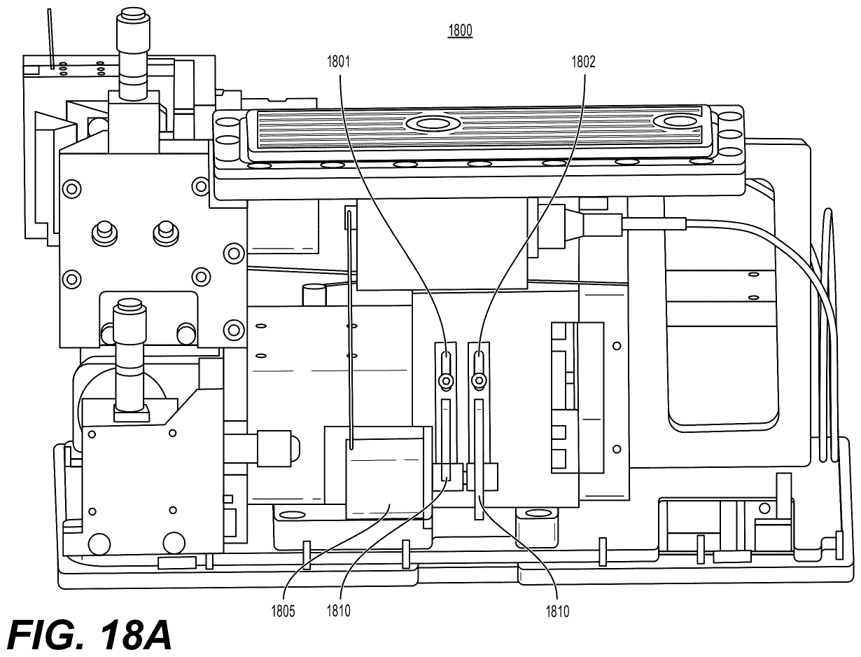

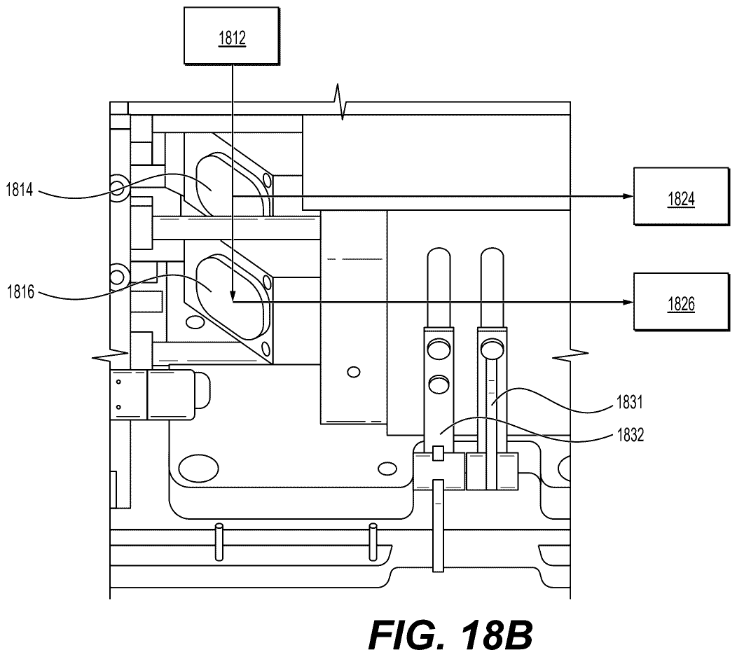

FIG. 18A depicts a motor and a camshaft to insert and retract two filter-sliders into the side-optics path. The filters may be polarizing, wavelength-selective, or neutral density filters, depending on the information about the cells that is desired. The motor may be driven through software, so that different filters may be automatically positioned in the optical train at different times during a test.

For example, one way of differentiating eosinophils and neutrophils from each other may be to measure the change in polarization that results from scattering events. However, the polarizing filter attenuates fluorescent light that may be used for distinguishing other types of cells from each other. One or more embodiments may provide the ability to automatically insert and retract filters, coupled with an ability to flow the same particles through the flowcell multiple times, such that a single detector equipped with both a fluorescence emission filter and a polarization filter may be used, and different filters may be inserted as needed.

### Alternative Sample Cup Embodiments

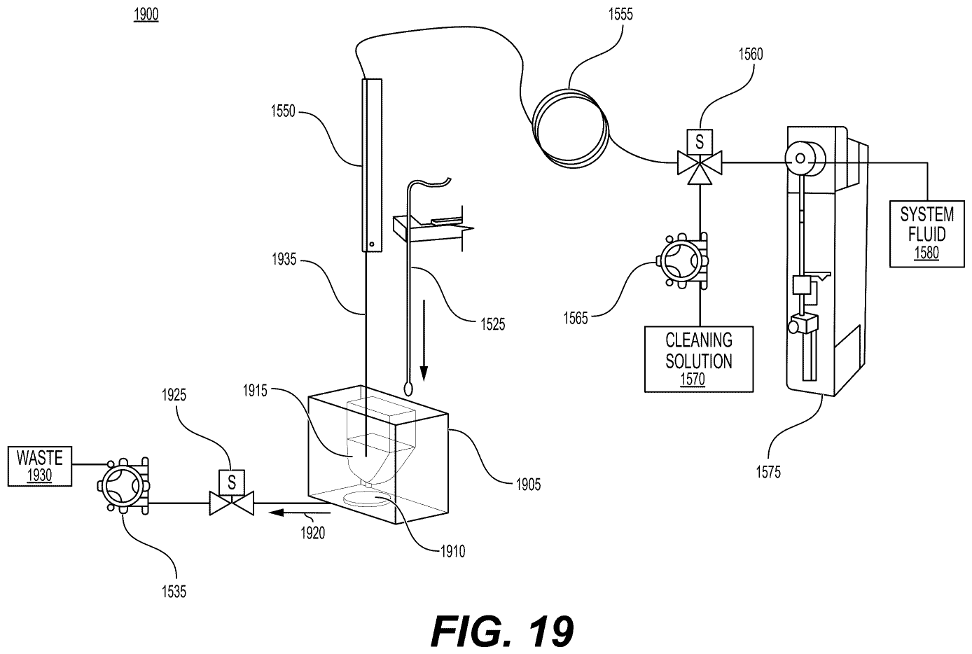

FIG. 19 depicts a simplified sample cup having a single waste port. One or more embodiments may provide one end of the flowcell is either directly placed in the sample cup or a sample tube connected to the flowcell may be submerged in the sample cup. The opening of the sample cup may be large enough that both the sample tube and the pipettor can access it at the same time.

With modifications according to the descriptions provided herein, the same use steps illustrated in FIG. 17A-17I may be used with this or other embodiments described herein. One or more embodiments may provide advantages including the simplicity of the sample cup. Furthermore, a sample tube may not need to be physically connected to the sample holder, instead the end of the sample tube may be submerged in the sample during aspiration of the sample into the flowcell. This may lead to fewer connections with potential for leaks, and fewer transitions from one inner diameter to another that might disturb the flow. However, because the sample tube is not connected to the sample cup, residual sample volume may be left in the sample cup during aspiration operations.

Low-Cost and Modular without Sacrificing Data Quality:

One or more embodiments may include a cytometer that is low-cost and modular without sacrificing data quality. The optical train described herein may permit uniform interrogation of the entire cross-sectional area of a large-diameter flow-channel, which may obviate the need for sheath fluid. This may enable the collection of clinical-quality data, while making the system less expensive, more portable, and easier to maintain than traditional sheathed cytometers. The sheathless nature of the flow, and the way in which sample is drawn into the flowcell also means that the module may have the capability of pulling and pushing the sample through the flowcell multiple times, with each pass through the flowcell, providing additional information about the sample.

One or more embodiments may be augmented by the automated filter-insertion and retraction capabilities, which may permit a user or system to vary the interrogation parameters dynamically during each pass. The sample cup and flowcell may be reusable and may be cleaned between runs in an automated way, requiring no user intervention. These features when, used synergistically, enable the cytometer to have fewer channels and use fewer detectors than traditional sheath-flow-cytometers.

### Easy to Maintain and Tolerant of Misalignments

One or more embodiments may provide a cytometer that is easy to use and maintain, requiring no intervention from the user between runs.

One or more embodiments may provide that the cytometer is tolerant of some beam misalignments. In some embodiments the oversized astigmatic beam that fills the cross-section of the flow-channel will still fill the cross-section of the flow channel and interact with particles, even if it is off-center. This is quite different from sheathed-flow cytometers which must ensure that the beam remains centered on the sample-carrying core fluid. Because the laser beam provides a highly-astigmatic beam that overfills the entire channel, particles passing through the channel can be counted even if the beam is misaligned.

One or more embodiments may provide that the cytometer is also designed to accommodate misalignments of the flow-channel with respect to the side-optics. In one or more embodiments, each side optics channel is configured such that its detector is situated at the exit pupil of the side-optics imaging system. In this configuration, both the intensity and spot-size of light received at the detectors are relatively immune to changes in the precise location of the object.

### Modular

One or more embodiments may provide a module system. One or more embodiments may provide that the cytometry module may share system-level resources, such as a housing, motion system, pipettor, syringe pumps, system fluid tank, degasser, waste pump, waste tank, control electronics, and software with other modules in an instrument.

### Flow Rate

One or more embodiments may provide the flow rate of sample through the flowcell of the cytometer module is controlled by a pump that pulls sample from the sample cup, through the flowcell, and into a sample loop. One or more embodiments may provide the pump is a displacement pump, such as a syringe pump or piston pump. One or more embodiments may provide the flow rate is between 30 and 500 microliters per minute. One or more embodiments may provide the flow rate is constant during a run, while in other embodiments the flow rate is changed. One or more embodiments may provide the cytometry module includes at least one sensor, such as a flow-sensor or a differential-pressure sensor that can be used to measure the flow rate. One or more embodiments may provide the flow rate is altered for different assays.

### Fluidic System

One or more embodiments may include a fluidic system comprising the cytometry module of the present disclosure and a downstream pump. One or more embodiments may provide the pump is attached to a tube or channel that is connected to a fluidic valve, wherein when the fluidic valve is closed, the pump is fluidically disconnected from a fluid container, such as a cuvette or cup or vessel, and wherein when the valve is open, the pump is fluidically connected to the fluid container. One or more embodiments may provide the fluid container, which can be a sample cup or a cuvette.

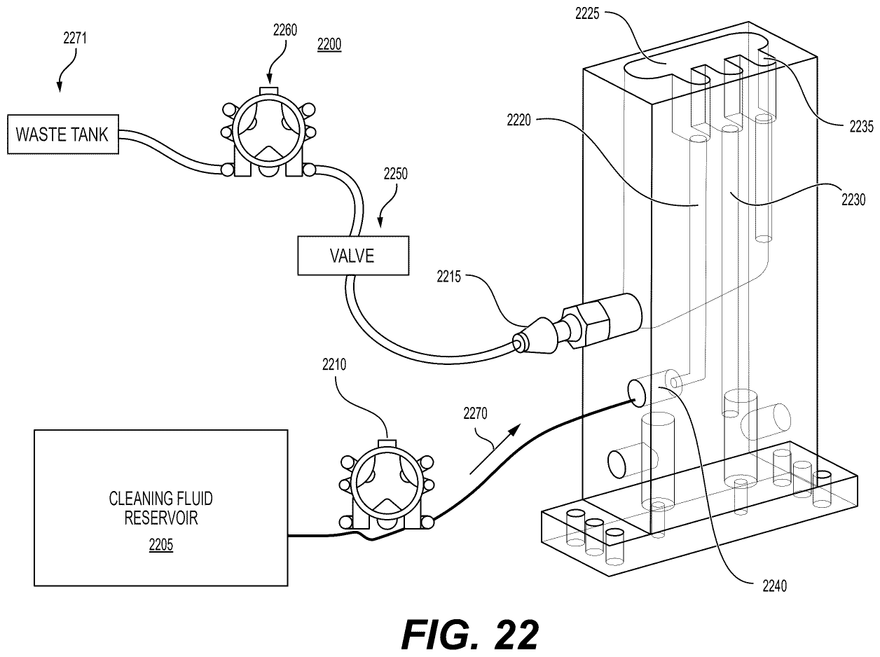

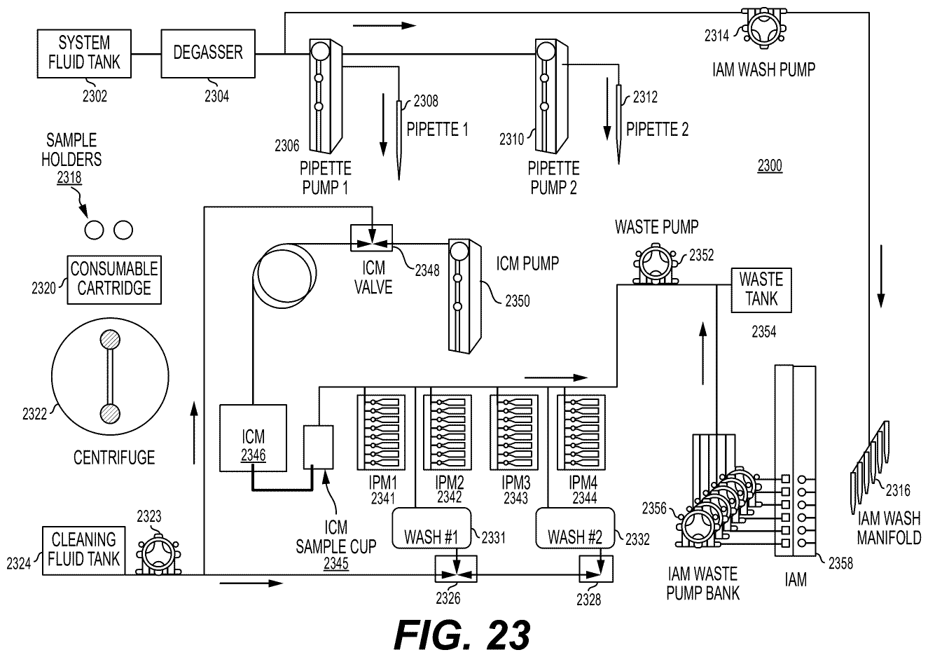

One or more embodiments may provide the system further comprises one or more waste/wash stations, each of which may also be connected to the pump as shown in FIG. 22. One or more embodiments may provide the waste/wash station may be connected to the pump through a valve, such that when the valve is open, the pump is fluidically connected to the waste/wash station. One or more embodiments may provide the system further comprises a waste output and a waste tank. An example of a waste output and a waste tank may be shown in FIG. 22.

One or more embodiments may provide the system further comprises a cleaning fluid tank. One or more embodiments may provide the fluidic system further comprises a cleaning pump. An example of a cleaning pump may be shown in FIG. 22.

One or more embodiments may provide the fluidic system further comprises a degasser. This is depicted, for example, in FIG. 23. One or more embodiments may provide the fluidic system further comprises one or more pipettes. One or more embodiments may provide the fluidic system further comprises a mixing apparatus. One or more embodiments may provide the fluid container is configured to hold a sample and/or one or more reagents. One or more embodiments may provide the fluid container is a reaction vessel. One or more embodiments may provide the system comprises a thermal heater.

Another aspect of the present disclosure includes a system for performing measurements of a fluid using the cytometry module, the system comprising the cytometry module of the present disclosure, and a pump.

The modular cytometer of the present disclosure may may be part of a system such as that shown in FIG. 23. FIG. 23, for example, depicts one cytometer module (ICM). One or more embodiments may provide the system further comprises a pump. A pump of the system may be used to remove fluid through an outlet of one or more fluid containers of the module(s). In one or more embodiments, the fluid container associated with the cytometry module is the sample cup, and the pump is connected to its waste output, and may be further connected to other module(s) within the system(s).

During waste removal, the fluidic pressure difference across the fluid in fluid containers may be formed with the use of, for example, a pump that may be appropriately connected to the outlet, of one or more fluid containers of the one or more modules. For example, for FIG. 23 this may include the “waste pump.” Alternatively, the fluidic pressure may be formed with the use of a pressure that is applied to the inlet end of the fluid container, resulting in fluid that may be pushed out of the outlet.

One or more embodiments may provide the waste pump is a peristaltic pump, a membrane pump, or a diaphragm pump. One or more embodiments may provide the waste pump comprises an evacuated gas cylinder, configured to create a pressure difference across the fluid in the fluid container by pulling on their outlets. One or more embodiments may provide the pump is a pneumatic pump. One or more embodiments may provide the pump comprises a pressurized gas cylinder to create a pressure difference across the fluid in the container by applying pressure to their inlets.

### Waste Tank

One or more embodiments may provide such as that shown in FIG. 23, the system of the present disclosure comprises a waste tank. One or more embodiments may provide a system where if a waste tank is present, the system comprises a channel or tube connecting the one or more individual fluid containers in the one or more modules to the waste tank. The waste tank may include a common single waste collection reservoir (storage volume), for example as depicted in FIG. 22 and FIG. 23.

### Cleaning Fluid Tank

One or more embodiments may provide the system further comprises a cleaning fluid tank. The cleaning fluid tank may be fluidically connected to a pipettor so that the pipettor can dispense cleaning fluid into the fluid container to clean them. Alternatively, the cleaning fluid may be directly connected to the fluid container through a valve, or through fluidic inlet tubes. This may include, for example, the configuration depicted in FIG. 23. In addition, or alternatively, the cleaning fluid tank may be fluidically connected to waste/wash stations, as shown in FIG. 22. In this case, the pipettor may aspirate cleaning fluid from the waste/wash stations and bring it to the fluid containers, (such as the ICM sample cup) to clean them. In some embodiments, no cleaning fluid may be required, and the pipettor may dispense system fluid into the fluid containers (including the ICM sample cup) to clean them.

### Cleaning Pump

One or more embodiments may provide the system further comprises a cleaning pump. The cleaning pump may be used to pump cleaning fluid from the cleaning fluid tank to the ICM flowcell and sample-cup, and to waste/wash stations, where it may be used to clean the pipettors. In some embodiments, no cleaning pump may be required because no specialized cleaning fluid is required.

### Degasser

One or more embodiments may provide the system further comprises a degasser. The degasser can be used to degas fluids before they are used in the system.

### Pipettes

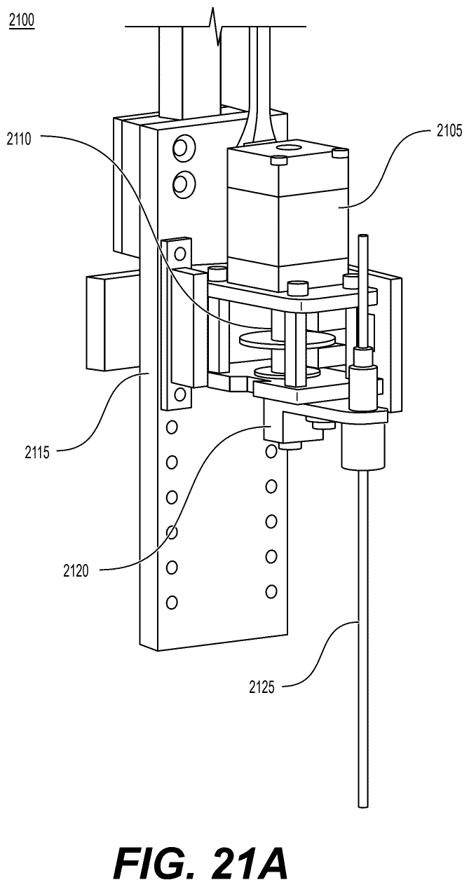

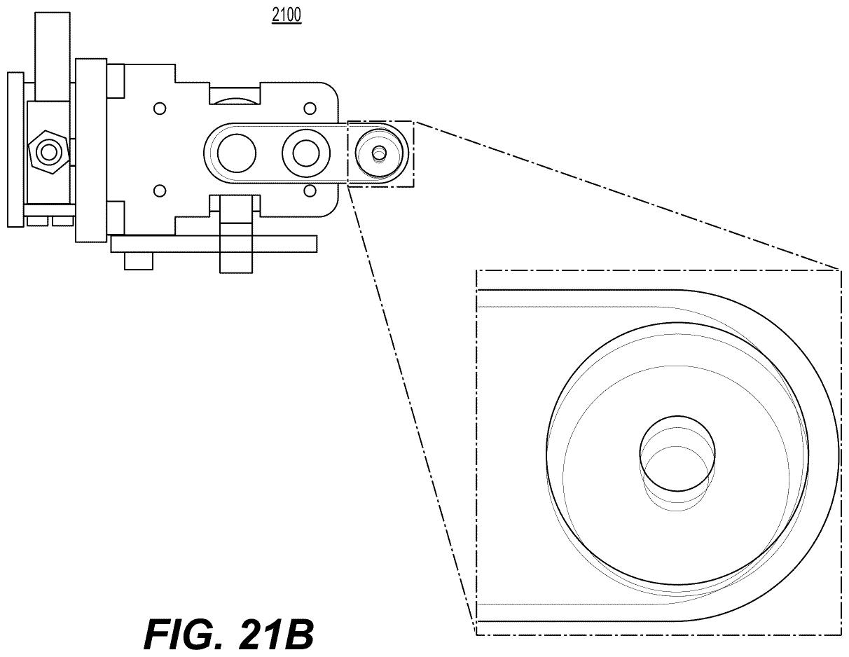

One or more embodiments may provide the system further comprises one or more pipettor(s) for pipetting and/or mixing the sample and/or reagents in the cuvette(s). One or more embodiments may provide the pipettor(s) are automated pipettor(s). One or more embodiments may provide the system comprises a plurality of pipettors. One or more embodiments may provide the pipettor(s) are mounted to arms on a robot, such as an XYZ gantry robot to enable them to move to different places in the system. An example of the pipettor configuration and orientation may be depicted for example in FIGS. 21A-21B.

### Waste and Wash Stations

As shown in FIG. 22, the system may further comprise one or more waste and wash stations. The waste/wash station(s) may be used to accept waste from the pipettor(s) and to wash the inside and outside of the pipettors.

An exemplary waste/wash station that may be used with the system may be depicted in FIG. 22. The waste/wash station may include, for example, a shallow blind hole that can be used to clean a relatively short portion of the end of the pipette. The waste/wash station may also include a deep blind hole that can be used to clean a longer portion of the pipette. The waste/wash station also may include a pipette cleaning fluid input that communicates through a fluidic channel to a pipette cleaning fluid hole. The waste/wash station may further include a small waste reservoir, which may be filled by spill-over from liquids exiting the cleaning fluid hole, the shallow cleaning hole, and the deep cleaning hole.

During a cleaning operation, the pipette may first optionally eject its contents into the small waste reservoir and then move to the blind shallow cleaning hole and prime system fluid into it. This priming bathes the inside and outside of the pipette with system fluid and is often sufficient to clean both the inside and outside of the pipette.

If a more stringent clean is required, the pipette may position itself in the “extra-cleaning-fluid hole.” A cleaning-fluid pump then may pump cleaning fluid into the extra-cleaning fluid hole, where it bathes the outside of the pipettor, and may be pulled into the inside of the pipettor if desired. Next, the pipettor may move to the deep cleaning hole, and there may perform a series of system-fluid primes to remove residual cleaning fluid from the pipette.

### Consumable Reagent Plate

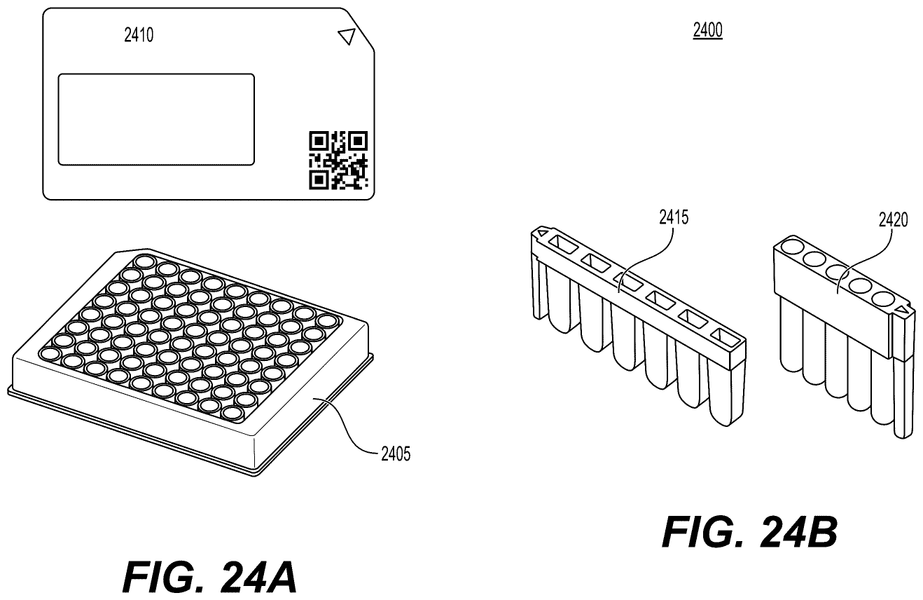

As depicted in FIG. 24A, the system may further comprise one or more consumable reagent plates. The reagent plate(s) may hold the reagents that may be used in the assay(s). When the reagents are used up, the consumable reagent plate may be replaced.

### Mixing Apparatus

One or more embodiments may provide the system further comprises a mixing apparatus. A non-limiting example of a mixing apparatus is a stir-pipettor in which the pipette is mounted on a flange that is eccentrically attached to a motor shaft. When the motor spins, the movement of the end of the flange where the pipette is mounted may describe an oval or circular arc. The motion of the pipette may be used to efficiently stir liquids in fluid containers. An example of a stir-pipettor may be depicted, for example, in FIGS. 21A-21B.

In some embodiments the movement of the pipette tip when the motor is actuated describes a rough circle having a diameter of 1 mm, 2 mm, 3 mm, 4 mm, or 5 mm. One or more embodiments may provide the motor operates at 5, 10, 15, 20, 25, 30, 35, or 40 revolutions per minute, causing the pipette to also spin at these frequencies.

Other stirring embodiments include magnetic stir bars or magnetic balls that may be placed inside fluid containers and actuated with a magnet, such as a bar magnet or electromagnet that may be positioned outside of the fluid container. Movement of the external magnet affects movement of the balls or bars within the fluid container, thereby creating turbulence that mixes the fluids. Another non-limiting example of a mixing apparatus includes mechanical features such as propellors or impellors that move into the fluid container to mix and retract from the cuvettes during measurement operations. In one or more embodiments, the system comprises a mechanical system of mixing one or more fluids within the fluid container. The mechanical system of mixing may include one or more of: a stir-pipettor, one or more bar magnets, an impeller, and one or more propellers. The mechanical system of mixing may include the use of aspirating and dispensing fluid from the pipette tip. Such repeated aspirate/dispense cycles, coupled with moving the probe tip up and down may be used to mix fluids. One or more embodiments may provide the system comprises a non-mechanical system of mixing fluids within the fluid container.

While the invention has been particularly shown and described with reference to a preferred embodiment and various alternate embodiments, it will be understood by persons skilled in the relevant art that various changes in form and details can be made therein without departing from the spirit and scope of the invention.

All references to issued patents and patent applications cited within the body of the instant specification are hereby incorporated by reference in their entirety, for all purposes.

FIG. 1 depicts a block model of the optical path in the cytometer that is the object of this invention, according to one or more embodiments. System 100 may include a collimated laser 110, focusing optics 120, flowcell 130, side scatter optics 140, processor 1200, and forward scatter optics 150. A collimated laser 110 may be directed through focusing optics 120 which may generate a highly astigmatic beam. The beam may then pass through a flowcell 130, where it may interact with particles in a channel of flowcell 130. Resultant scattered-light may be transmitted to the forward-scatter optics 150 and side-scatter optics 140. Processor 1200 may be a processor configured to capture, plot, and analyze the light received by the side scatter detector channels and the light received by the forward scatter detector channels to determine at least one characteristic of the at least one cell received by the flowcell. Processor 1200 may collect one or more datasets representing different characteristics of the one or more particles flowed through the flowcell. Side-scatter optics 140 may include one or more optical components that convey the scattered light from the flowcell to the side-scatter detectors. This may include one or more lenses, a beam-splitter, and a mirror that sends the light to two photomultiplier tubes (PMTs). Forward-scatter optics 150 may include one or more optical components similar to side-scatter optics 140. Side-scatter may include the signals measured by the side-scatter photomultiplier tubes (PMTs).

System 100 may be a modular sheathless flow-cytometry system, as described herein. In such a system, particles in a channel may not be confined by sheath fluid, but may be free to flow throughout the full cross-sectional area of the channel, and where furthermore, in or at any point in the full cross-sectional area, they may pass through a laser beam with substantially uniform intensity.

FIG. 2 depicts a portion of the optical train that includes the focusing optics (L1 and L2), the flowcell, and the forward-scatter mask, according to one or more embodiments. System 200 may include optical train side view 210 and optical train top view 220. Optical train side view 210 may include a Y-axis and Z-axis view of the optical train including focusing optic 212, focusing optic 214, flowcell 216, and forward scatter mask 218. Optical train top view 220 may include X-axis and Z-axis views of the optical train, including optic 222, focusing optic 224, flowcell 226, and forward scatter mask 228.

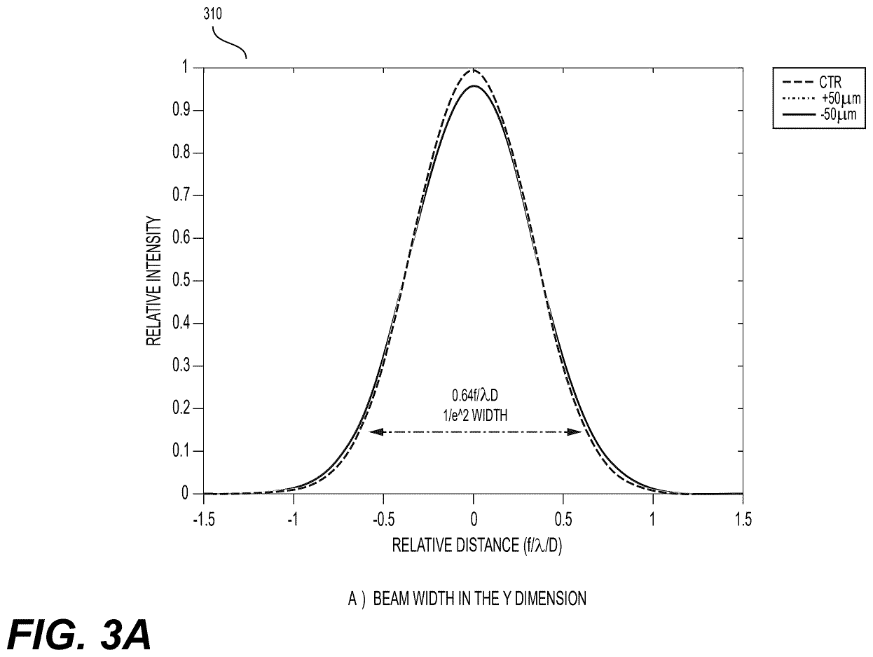

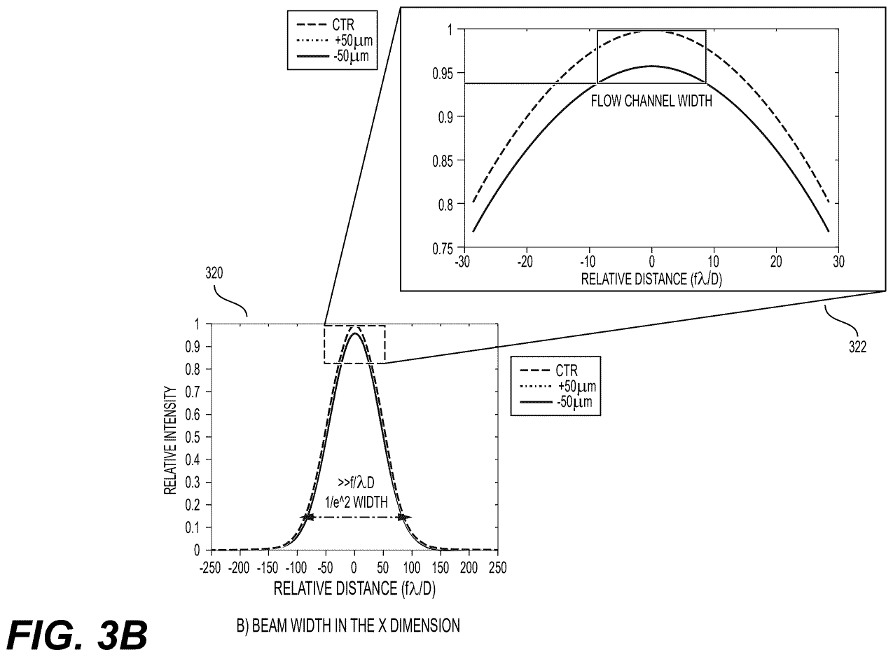

FIG. 3A depicts a model of a beam intensity profile at a flowcell in the Y-dimension, according to one or more embodiments. Graph 310 includes a beam width including an intensity profile in the Y-dimension. FIG. 3B depicts a model of a beam intensity profile at a flowcell in the X-dimension, according to one or more embodiments. Graph 320 includes a beam width including intensity profile in the X-dimension, and a zoomed-in graph 322 includes a flow channel width. Graph 310 and graph 320 include a model of the beam profile at the flowcell, depicting normalized intensity vs. distance. The profile dimensions are expressed relative to the quantity fλ/D, where f=the focal length of the L1 lens, D is the size of the aperture stop in the system, and A is the wavelength of light.

Graph 310 illustrates the modeled beam profile at the flowcell in the Y-dimension. The tightly-focused beam diameter (the point at which the intensity drops to 1/e\hat{ }2, or ˜13% of its maximum) is 0.64 fλD, where f=the focal length of the L1 lens, D is the size of the aperture stop in the system, and A is the wavelength of light. Graph 320 illustrates the modeled beam profile at the flowcell in the X-dimension. In this dimension, due to the action of the cylindrical lens, the beam at the flowcell has a width>>fλD. Thus, at the flowcell, the beam is extremely asymmetric; it is a narrow ellipse.

Zoomed-in graph 322 depicts three curves which illustrate the X-dimension intensity profile of the focused ellipse of light, at three different z-positions in a 100×100 micron-square channel. These locations are the front face (solid curve, −50 um), center (dashed curve), and back-face (alternating dash-dot curve, +50 microns) of the channel. It can be seen that the normalized intensity over this 100×100 um square-area varies by just 6%, ranging from a minimum of 0.94 to a maximum of 1.0 at the very center of the channel. The uniform intensity of the beam across the full area of the channel means that all particles of the same size and index of refraction that pass through the beam at any location in the channel cross-section will scatter substantially the same intensity of light, and thus be counted and identified properly.

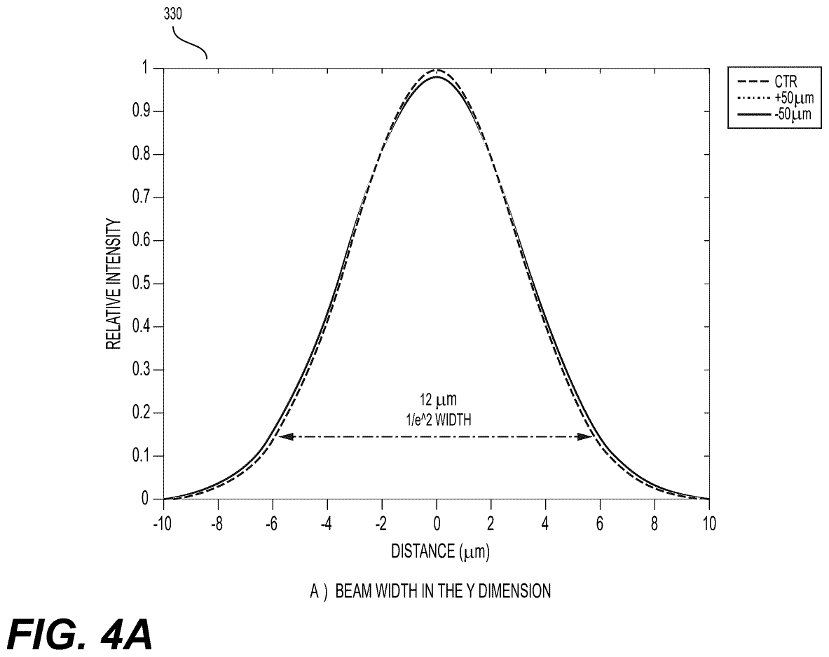

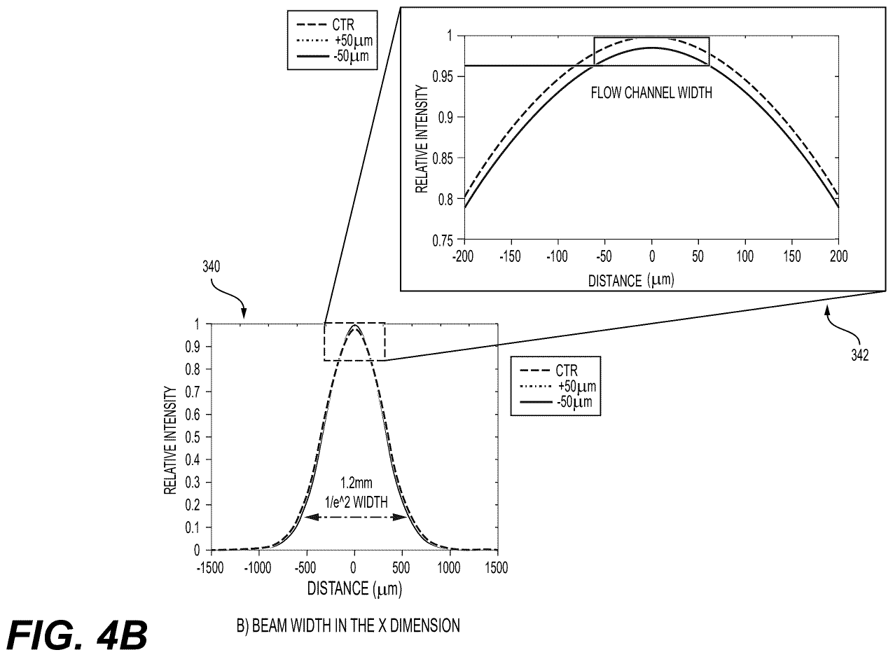

FIG. 4A depicts a model of a beam intensity profile at a flowcell in the Y-dimension for a particular set of focal lengths of lenses, an aperture stop size, and a wavelength, according to one or more embodiments. Graph 330 includes a model of the beam profile at the flowcell, depicting normalized intensity versus distance for the specific combination of f(L1)=8 mm, f(L2)=−20 mm, D=8 mm, and λ=640 nm.

FIG. 4B depicts a model of a beam intensity profile at a flowcell in the X-dimension for a particular set of focal lengths of lenses, an aperture stop size, and a wavelength, according to one or more embodiments. Graph 340 includes a beam width including intensity profile in the X-dimension, and zoomed-in graph 342 includes a flow channel width. Graph 340 includes a model of the beam profile at the flowcell, depicting normalized intensity vs. distance for the specific combination of f(L1)=8 mm, f(L2)=−20 mm, D=8 mm, and λ=640 nm.

Graph 330 illustrates the modeled beam profile at the flowcell in the Y-dimension. The tightly focused beam diameter (the point at which the intensity drops to 1/e\hat{ }2, or ˜13% of its maximum) is 12 μm. Graph 340 illustrates the modeled beam profile at the flowcell in the X-dimension. In this dimension, due to the action of the cylindrical lens, the beam at the flowcell has a width of 1.2 mm. Zoomed-in graph 342 depicts three curves which illustrate the X-dimension intensity profile of the focused ellipse of light, at three different z-positions in a 100×100 micron-square channel. These locations are the front face (solid curve, −50 um), center (dashed curve), and back-face (alternating dash-dot curve, +50 microns) of the channel. It can be seen that the normalized intensity over this 100×100 um square-area varies by less than 5%. FIG. 4A and FIG. 4B show just one example of the many sets of values for f(L1), f(L2), D, and A that can be used to create the conditions depicted generally in FIG. 3A and FIG. 3B.

FIG. 5 depicts a table of aperture stop sizes, lens focal lengths, and wavelengths, which may produce the optical profiles of FIG. 3A-3B. Other exemplary options of specific examples of values depicted generally in FIG. 3A and FIG. 3B are shown in table 500 depicting wavelength and focal length options. Some tolerance is allowable in the specific lens values to accommodate manufacturing and material variations, as well flexibility in the design size of the illuminating beam profile. Table 500 depicts specific, practical combinations of aperture size (D), Lens focal lengths (f1, and f2), and wavelength (λ) that result in the conditions depicted in FIG. 3A and FIG. 3B.

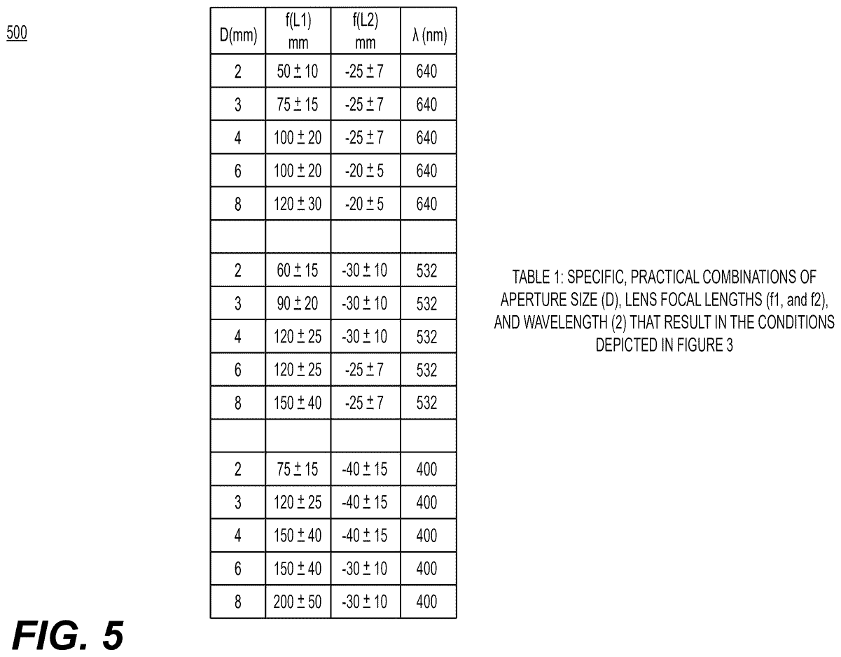

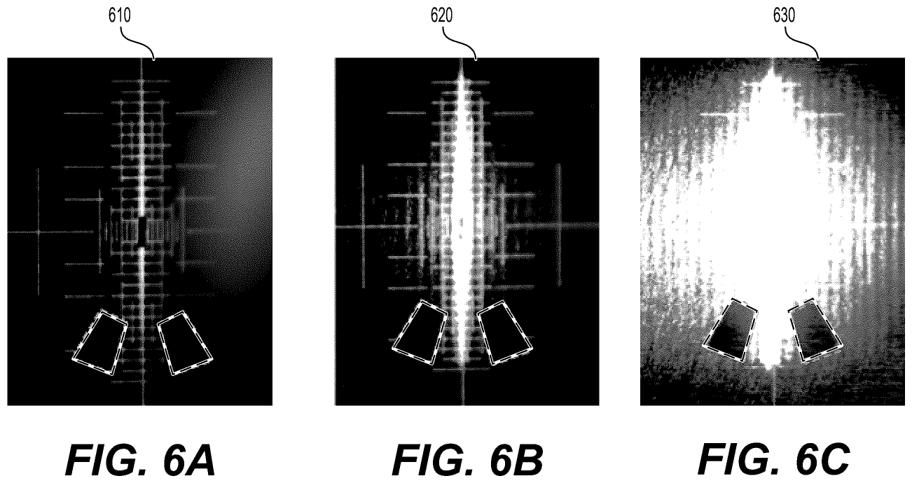

FIG. 6A-6C depict a beam on a forward scatter mask, according to one or more embodiments. Here, the beam is focused in the X-dimension, and has become elongated in the Y-dimension. Thus, at the forward scatter mask, the beam is an elongated ellipse, perpendicular to the elongated ellipse of light at the flowcell.

FIG. 6A depicts an elliptical low-power beam on a forward scatter mask with a neutral density filter limiting the intensity of light, according to one or more embodiments. Graph 610 shows the beam at 1 mW laser power, with a neutral density (ND) filter (optical density=2) having further reduced the power by 100×, so that only the central (brightest) portion of the beam is visible. In this figure, the focused beam resembles the profile predicted from simple ray tracing.

FIG. 6B depicts an elliptical low-power beam on a forward scatter mask without a neutral density filter, according to one or more embodiments. Graph 620 shows the beam, still at 1 mW laser power, but with no ND filter. Here, a more realistic view of the spatial extent of the beam can be seen, which is much broader than the idealized ellipse predicted by ray-tracing. In part, this is because the diffraction-limited size of a beam is always larger than that predicted by a simple ray-trace model. But a more important phenomenon is at play. Because the wide elliptical beam hits the edges of the flow channel, diffraction lines are generated that extend beyond the extent of the focused beam.

FIG. 6C depicts an elliptical beam on a forward scatter mask at a laser power of 75 mW, according to one or more embodiments. Graph 630 shows the beam at 75 mW power. Here, the diffraction lines can be seen to extend substantially into the FSC1 apertures, and beyond.

Because the spatial extent of the beam is broad it can overlap the FSC1 apertures on the mask (shown outlined in dashed lines in FIGS. 6A-6C). This may be undesirable because the DC light that enters the mask apertures raises the background (noise) level and creates coherent interference with light scattered from particles. To prevent coherent interference from creating undesirable amplitude variations, a system should limit the amount of DC light entering the forward scatter apertures. This may be achieved by putting an aperture stop in the collimated beam. Adding a stop to reduce the beam diameter reduces the angular extent of the bundle of light that passes through the system, and thus the y-dimension extent of the laser as projected onto the FSM. It will be apparent to practitioners of the art that the same effect can be created by reducing the collimated beam diameter, and/or by limiting the physical diameter of the focusing lens (L1).

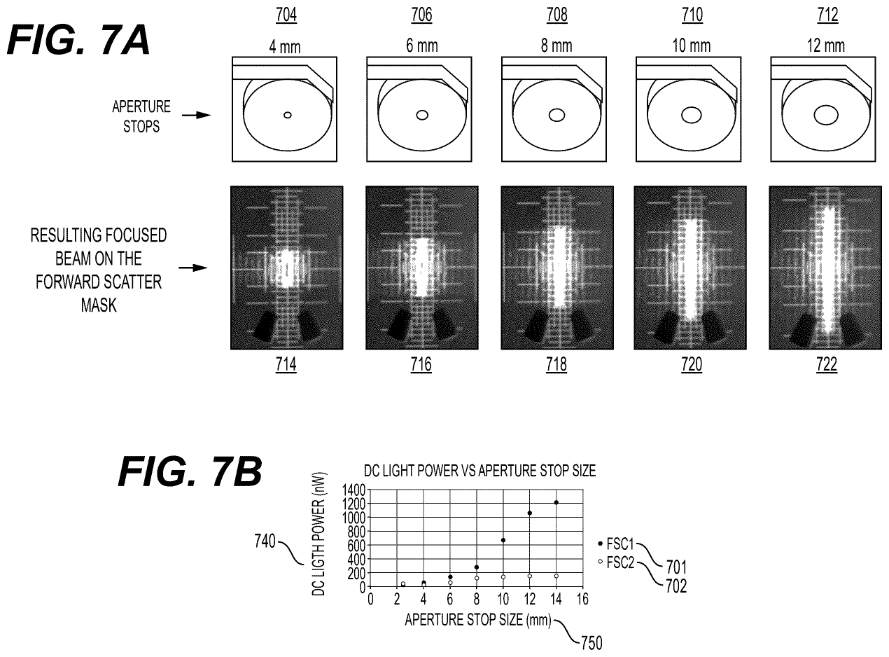

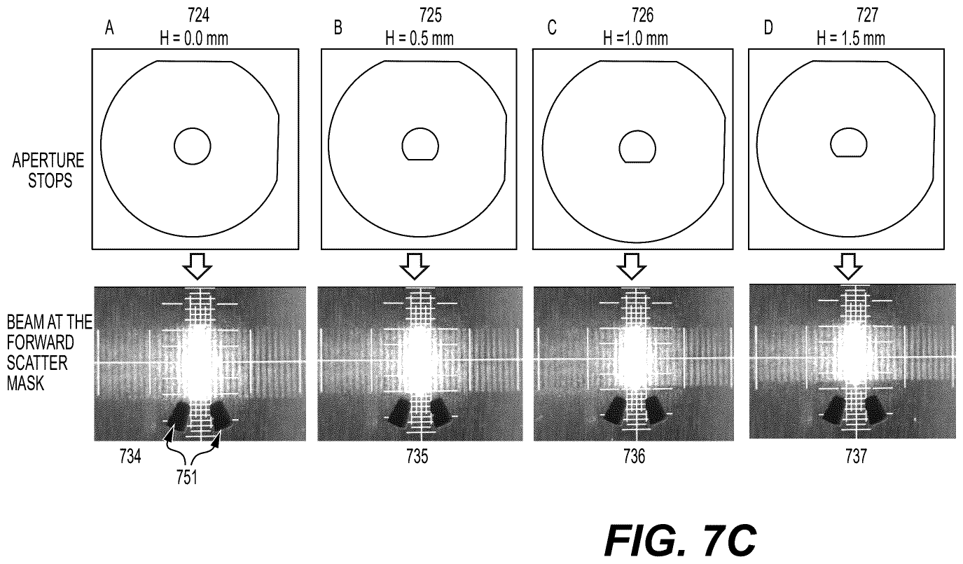

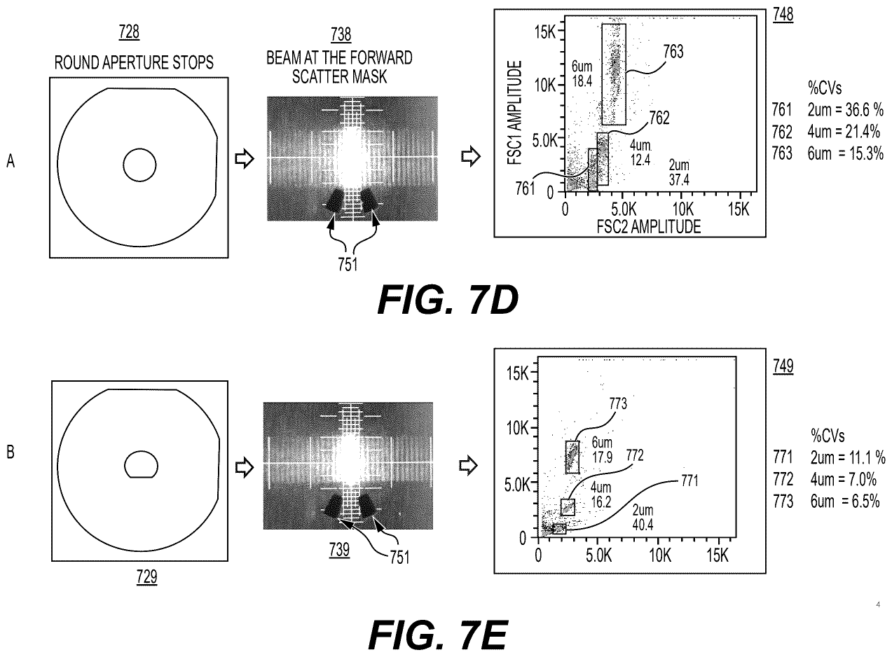

FIG. 7A depicts radially symmetric aperture stops of different diameters that may be positioned in a collimated beam between mirrors, according to one or more embodiments. FIG. 7A shows the effect of inserting an aperture stop into the collimated beam (prior to the beam-shaping optics). In FIG. 7A smaller diameter aperture stops are shown to result in reduced vertical extent of the beam on the forward-scatter-mask. FIG. 7A includes 4 mm aperture stop 704 with resulting focused beam 714 on the forward scatter mask apertures, 6 mm aperture stop 706 with resulting focused beam 716 on the forward scatter mask apertures, 8 mm aperture stop 708 with resulting focused beam 718 on the forward scatter mask apertures, 10 mm aperture stop 710 with resulting focused beam 720 on the forward scatter mask apertures, 12 mm aperture stop 712 with resulting focused beam 722 on the forward scatter mask apertures. The system described herein may include an aperture stop as described, and the aperture stop may be chosen or selected so as to limit a spatial extent of a focused beam on the forward scatter mask, and thereby substantially avoid one or more forward scatter mask apertures.

FIG. 7B depicts the power of un-scattered light on first and second forward scatter detectors as a function of aperture stop diameter, according to one or more embodiments. FIG. 7B includes DC light power 740 on the Y-axis and aperture stop size 750 on the X-axis, and plots of the DC light measured at FSC1 701 and of the DC light measured at FSC2 702. In FIG. 7B, it is shown that the smaller diameter apertures result in a correspondingly reduced amount of DC light that enters the FSC1 and FSC2 apertures (FIG. 7B). Particularly noteworthy in the graph is the jump in DC light measured at FSC1 that occurs at the 10 mm aperture. The large increase in DC light observed at the FSC1 detector when the aperture-stop is increased to 10 mm occurs because the beam at the forward-scatter-mask now extends vertically between the FSC1 apertures.

FIG. 7C depicts aperture stops having an 8 mm diameter, according to one or more embodiments. FIG. 7C includes an 8 mm diameter aperture stop 724 with no asymmetry with resulting focused beam 734 on the forward scatter mask, aperture stop 725 having an asymmetric chord of length of 0.5 mm with resulting focused beam 735 on the forward scatter mask, aperture stop 726 having asymmetric chord length of 1.0 mm with resulting focused beam 736 on the forward scatter mask apertures, and aperture stop 727 having an asymmetric chord length of 1.5 mm with resulting focused beam 737 on the forward scatter mask apertures. The system described herein may include an asymmetric aperture stop as described which may be shaped so as to limit the spatial extent of the focused beam on the forward scatter mask, and thereby substantially avoid one or more forward scatter mask apertures, while simultaneously maintaining as much power in the beam as possible.

FIG. 7D depicts a radially symmetric aperture stop 728 according to one or more embodiments. Symmetric aperture stop 728 may produce beam 738 on the forward scatter mask. The beam is very close to forward scatter mask apertures 751, and an elevated amount of DC light may be admitted into the apertures.

Under these conditions, graph 748 may result from scattering off of 2, 4, and 6 um particles. Graph 748 includes scatter data 761, scatter data 762, and scatter data 763. Scatter data 761 may indicate percent coefficient of variation (% CV) of the voltages measured by the forward scatter one detector of 36.6% for 2 um. Scatter data 762 may indicate percent coefficient of variation (% CV) of the voltages measured by the forward scatter one detector of 21.4% for 4 um. Scatter data 763 may indicate percent coefficient of variation (% CV) of the voltages measured by the forward scatter one detector of 15.3% for 6 um. The large spread in the FSC1 amplitude is a direct result of coherent interference due to a relatively large DC component of the beam entering the FSC1 apertures.

FIG. 7E depicts radially asymmetric aperture stop 729, which produces beam 739 on the forward scatter mask. The asymmetric mask results in the beam being truncated near the forward scatter mask apertures 751. As a result, less DC light is admitted into the mask apertures. Scattering from 2, 4, and 6 um beads may produce graph 749. Graph 749 may include scatter data 771, scatter data 772, and scatter data 773. Scatter data 771 may indicate percent coefficient of variation (% CV) of the voltages measured by the forward scatter one detector of 11.1% for 2 um. Scatter data 772 may indicate percent coefficient of variation (% CV) of the voltages measured by the forward scatter one detector of 7.0% for 4 um. Scatter data 773 may indicate percent coefficient of variation (% CV) of the voltages measured by the forward scatter one detector of 6.5% for 6 um. Relative to the data of FIG. 7D, the reduced spread in the data of FIG. 7E is a direct result of having reduced the amount of DC light admitted into the mask apertures.

DC light entering the forward-scatter apertures results in a larger spread in the data because it causes coherent interference when it interacts with scattered light. That coherent interference may produce undesirable impacts on the data can be seen by considering the interference equation, Equation 1: Iₜₒₜ=I₁+I₂+2γ\sqrt{I₁I₂} sin (Φ₁₂) where I₁ is the scattered light intensity, I₂ is the DC light intensity, γ is the degree of coherence between the two beams, and Φ₁₂ is the phase angle between the scattered and DC light. The sine-term in Equation 1 means that the total intensity measured at the detector will oscillate. Because the sine wave spends more time near its extrema, the resulting distribution of pulse amplitudes is bimodal in time.

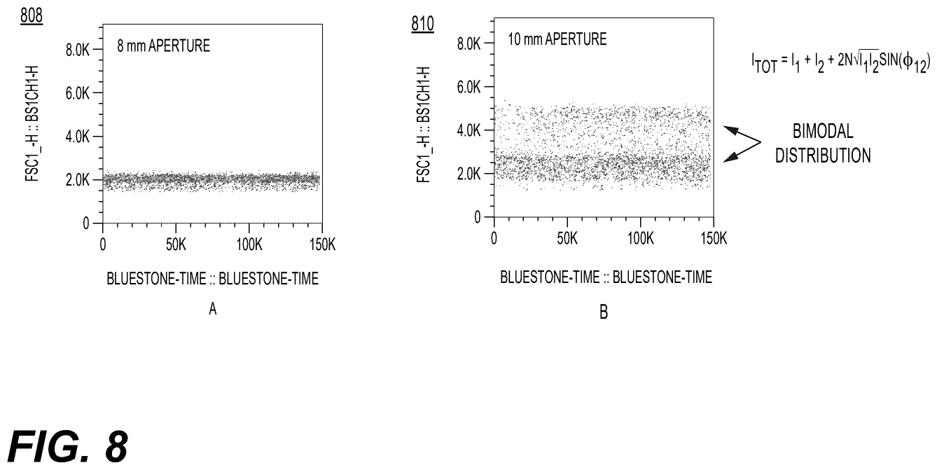

FIG. 8 depicts graphs of digitized-detector-voltage amplitude measured at a first forward scatter detector versus time for light scattered off particles flowing in a flowcell when the laser beam is limited by two different radially symmetric aperture stops, according to one or more embodiments. FIG. 8 shows the digitized voltage amplitudes measured by the FSC1 detector versus time, for 4 um diameter particles flowed in the flowcell. Graph 808 shows FSC1 digitized voltage amplitude versus time for 4 um particles when the vertical extent of the beam on the FSM is limited by an 8 mm aperture stop. Graph 810 shows FSC1 digitized voltage amplitude vs. time for 4 um diameter particles when the vertical extent of the beam on the FSM is limited only by a 10 mm diameter aperture stop.

As shown in graph 808, when the vertical extent of the beam on the FSM is limited by an 8 mm diameter aperture stop, the voltages resulting from scattering events adopt a tight normal distribution. In contrast, when the vertical extent of the beam on the FSM is expanded, as seen in graph 810 using the 10 mm diameter aperture stop, graph 810 shows the extra DC light admitted into the FSC1 apertures creates coherent interference that broadens the distribution of voltage measured at the detector into a classic bimodal distribution. The impact of this broadened voltage amplitude variation can be seen in the resulting scattergrams when particles are flowed through the flowcell.

FIG. 9A depicts graphs of digitized detector voltage measured at a first forward scatter detector versus digitized detector voltage measured at a second forward scatter detector for light scattered from particles flowed through a flowcell when the laser beam is limited by radially symmetric aperture stops of different diameters, according to one or more embodiments. FIG. 9A shows plots of the digitized voltages measured at FSC1 versus those at FSC2 when 4 um-diameter polystyrene beads are flowed through the flowcell, using 4 mm, 6 mm, 8 mm, 10 mm, and 12 mm aperture stops. Graph 904 includes data for a 4 mm diameter aperture stop, graph 906 includes data for a 6 mm diameter aperture stop, graph 908 includes data for an 8 mm diameter aperture stop, graph 910 includes data for a 10 mm diameter aperture stop, graph 912 includes data for a 12 mm diameter aperture stop.

The insertion of an aperture stop limits the vertical extent of the beam on the forward-scatter-mask, and also reduces the intensity of the beam at the flowcell, resulting in less light available to scatter off the particles of interest. FIG. 9A illustrates this: As the aperture stop diameter increases from 4 mm (graph 904) to 12 mm (graph 912), the mean value of the particle distribution increases on both axes (that is, the amount of light scattered off the particles and detected at FSC1 and FSC2 increases as a function of field-aperture size). This increase in power is desirable particularly for small particles because it improves the signal-to-noise ratio, and enables the detection of hard-to-see particles. Thus, when selecting an aperture stop, a balance may be reached, such that the aperture limits the extent of the beam to avoid apertures on the forward scatter mask, but does not attenuate the beam power too greatly.

FIG. 9B depicts the percent coefficient of variation (% CV) in the light intensity measured at forward scatter detector one as a function of the system aperture stop diameter from light-scattering events off 4-μm diameter round particles, according to one or more embodiments. FIG. 9B shows the % CV of these data as a function of aperture stop diameter, including graph 920. Graph 620 shows there is a large increase in the % CV when the aperture stop diameter is increased to 10 mm.

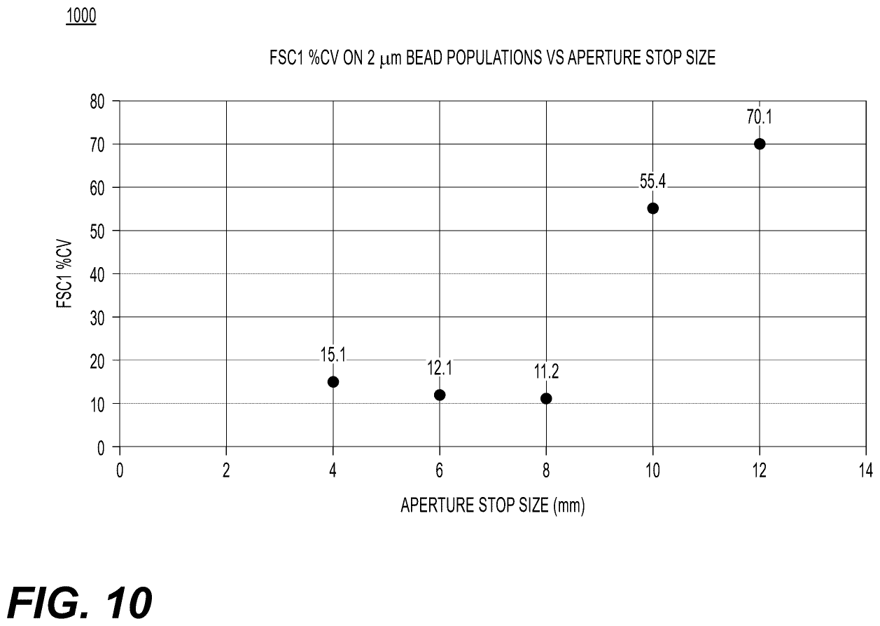

FIG. 10 depicts the percent coefficient of variation (% CV) in the light intensity measured at forward scatter detector one as a function of aperture stop diameter for 2-μm diameter round particles, according to one or more embodiments.

Graph 1000 shows the percent coefficient of variation (% CV) of the digitized voltages measured by the forward scatter one detector as the aperture stop diameter increases from 4 mm to 12 mm for 2 um particles. Here, it is evident that the % CV decreases as the field-aperture size increases from 4 to 6 to 8 mm in diameter, due to the improved signal-to-noise ratio. Only when the field-aperture diameter increases to 10 mm (and the vertical extent of the beam on the forward scatter mask starts to impinge on the FSC1 apertures) does the % CV increase.

It is therefore an aspect of this invention that the beam should be shaped to increase the power at the flowcell, while keeping the vertical extent of the beam at the forward scatter mask small enough that it does not interact with the FSC1 apertures.

To allow improved performance, the cytometer may be aligned so that the beam is focused at the flowcell in one dimension and at the forward-scatter-mask in the other. One method of alignment is to first adjust the focusing lens, L1, until the elliptical beam of light is focused in the X-dimension on the forward-scatter-mask. This may be done through active monitoring of the DC-level of the photodiodes behind the forward-scatter-apertures when no sample is flowing in the flowcell. When the amount of DC light is reduced to a minimum at the photodiodes, the proper focus has been achieved at the forward-scatter-mask. If the beam-shaping optics are aligned and are at their nominal values, this action will also properly focus the Y-dimension of the beam at the flowcell. However, it is a feature of this optical design that the beam can be somewhat defocused at the flowcell without impacting the ability of the cytometer to observe passing particles. A slightly defocused beam at the flowcell results in a slightly larger beam diameter at the flowcell, reducing the amount of light available for collection. However, this slight loss of intensity can be compensated for by increasing the power of the laser. In other embodiments, an additional degree of freedom may be provided so that a focus can be achieved at both the flowcell and the forward-scatter-mask. For instance, either the flowcell, or the forward-scatter-optical assembly may be capable of small translations in the Z-axis (parallel to beam propagation). Additionally or alternatively the distance between lenses L1 and L2 may be adjustable.

One or more embodiments may provide that the mask apertures may be at small scatter angles. To prevent DC light from entering these angles the beam must be restricted in the vertical extent on the forward scatter mask, which in turn limits the power available for scattering detection. One or more embodiments may adjust the mask apertures so that they are at larger scattering angles. In other words, while the locations of the mask apertures are typically driven by the desired Mie map, in some embodiments these locations may be altered to avoid undesirable interference effects. One or more embodiments may provide a forward scatter mask including one or more apertures sized and positioned to produce a dual-angle differential scatter Mie map.

There is an additional source of optical noise that may impact the results. As the light travels through the flowcell, it interacts not only with the particles flowing in the channel, but also with debris and defects in the flowcell channel and on the outside surfaces of the flowcell. Such interactions result in a different sort of interference pattern, characterized by misshapen pulses on all collected-scatter data (FSC1, FSC2, and the side-channels).

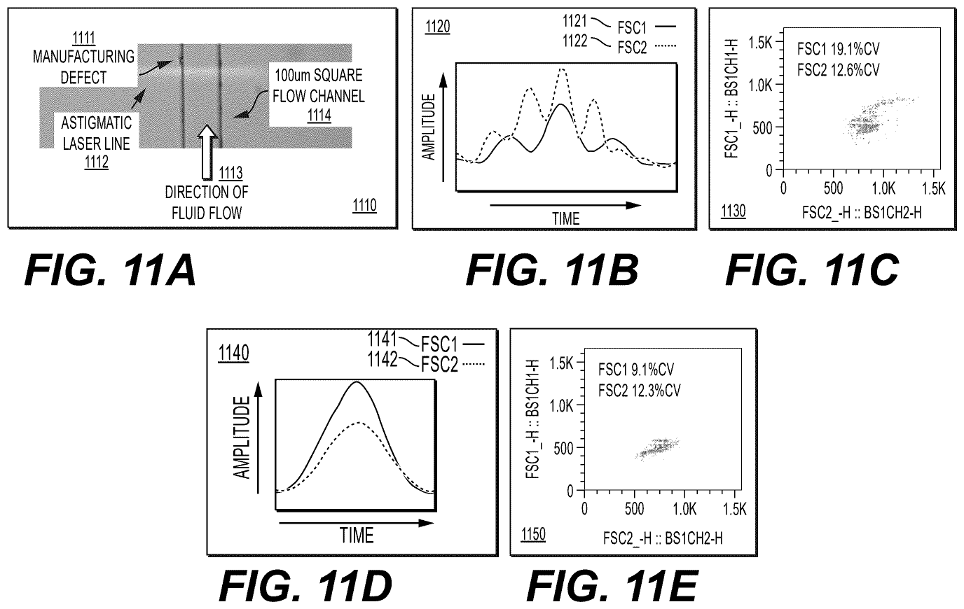

FIG. 11A depicts a microscope image of a square fluidic channel including a manufacturing defect on the wall of the channel, according to one or more embodiments. Image 1110 is a microscope image of a 100×100 um square fluidic channel, showing a manufacturing defect on the wall of the channel. Image 1110 includes a manufacturing defect 1111, an astigmatic laser line 1112, a direction of fluid flow 1113, and an exemplary 100 um×100 um square flow channel 1114.

FIG. 11B depicts interference from particles that flow near a defect, according to one or more embodiments. Graph 1120 is a voltage amplitude versus time graph representing the light received by forward-scatter detectors FSC1 and FSC2. Graph 1120 includes the measured voltage due to light received by the forward scatter 1 detector FSC1 1121 and the measured voltage due to light received by forward-scatter 2 detector FSC2 1122. When the laser line is positioned so that the laser line overlaps the manufacturing defect, particles that flow near the defect may result in voltage signals at the detector that include significant interference seen in graph 1120. This may have an undesirable effect of broadening population clusters.

FIG. 11C depicts broadened population clusters, according to one or more embodiments. Graph 1130 is a scattergram resulting from flowing 4 um polystyrene beads through the flow-channel. Graph 1130 may be broadened on both FSC1 and FSC2 axes by the poorly shaped scatter pulses and has a 19.1% CV in the FSC1 dimension.

FIG. 11D depicts a graph of more uniform pulses, according to one or more embodiments. Graph 1140 includes FSC1 1141 and FSC2 1142. Graph 1140 includes pulse shapes when the laser line is positioned so that it misses the defect (as shown in FIG. 11A), where pulse shapes tend to be uniform and the resulting scattergram is tighter, having a 9.1% CV in the FSC1 dimension (for example, FIG. 11E).

FIG. 11E depicts a graph of less broadened population clusters, according to one or more embodiments. Graph 1150 is a tighter scattergram having a 9.1% CV in the FSC1 dimension.

Interference due to defects and debris may affect cytometers, and it may be useful to the performance of an optical system to keep the optical path free of debris and defects, and may be useful specifically for cytometers using an illumination beam that overfills the inspection area and has a shallow convergence angle (i.e. a low numerical aperture). The optical train that focuses the scattered light onto photodiodes also may have a low numerical aperture and in combination these factors may produce a depth of focus that is longer than the axial depth of the flowcell channel. The large (overfilled) spatial extent of the beam and the long depth of focus of the beam may make this system vulnerable to defects and debris.

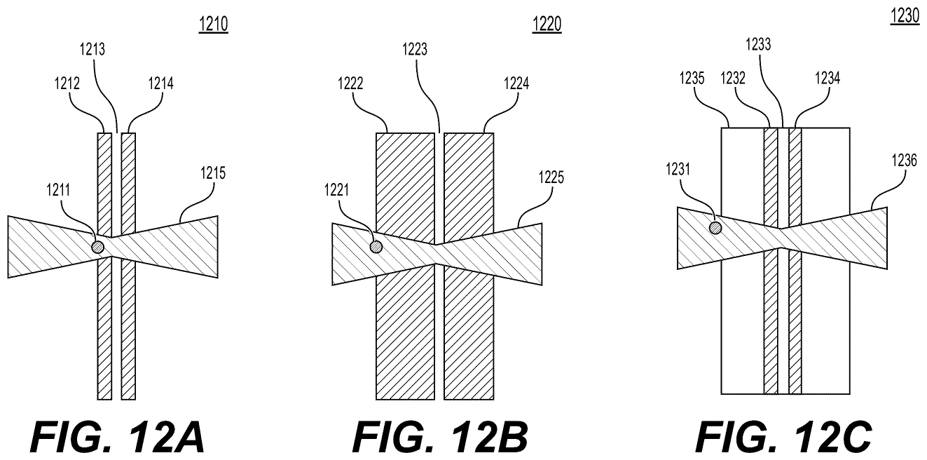

To prevent the detrimental impact of debris and defects on the data one or more embodiments may provide the flowcell is designed such that the illuminated entry and exit surfaces are outside the depth of focus of the illumination beam. This may be achieved by fabricating the flowcell from a monolithic material of sufficient thickness, or by enclosing the flowcell in a sealed assembly where the entry and exit faces are sufficiently distant from the flowcell. Some of these options may be illustrated, for example, in FIGS. 12A-12C.

FIG. 12A depicts a flowcell with thin walls, according to one or more embodiments. Flowcell 1210 includes contamination 1211, first wall 1212, path 1213, second wall 1214, and beam 1215. Contamination 1211 on the surface of the flowcell 1210 interacts with the beam near the beam waist, causing interference on scattered pulses.

FIG. 12B depicts a flowcell with thicker walls, according to one or more embodiments. Flowcell 1220 includes contamination 1221, first wall 1222, path 1223, second wall 1224, and beam 1225. Thicker walls first wall 1222 and second wall 1224 may shift contamination 1221 from the beam 1225, resulting in less interference with the scattered light. The flowcell walls may be 1 to 5 mm thick. For example, first wall 1222 and second wall 1224 may be 1 to 5 mm thick.

FIG. 12C depicts a flowcell with secondary packaging and thin walls, according to one or more embodiments. Flowcell 1230 includes contamination 1231, first wall 1232, second wall 1234, path 1233, secondary packaging 1235, and beam 1236. Secondary packaging 1235 also may shift the contamination 1231 away from the beam 1236, resulting in less interference with the scattered light. Secondary packaging 1235 may be an enclosure surrounding the flowcell configured to shift one or more contaminating particles away from a beam on the flowcell 1230. Separating interfering scattering sources from the beam focus in this way causes the illuminating beam to be spread out over a larger area compared to the beam waist at the flowcell channel. Furthermore, the image of the interfering particle at the detector will be out of focus. Together, for this system, these factors reduce the energy of the interfering wave by approximately:

$${( \frac{{w}_{0}}{{w}_{1}} )}^{3}$$

where w₀ is the radius of the beam at the beam waist, and w₁ is the radius of the beam at the entry or exit face.

The different interference phenomena that may affect this cytometer may have unique optical signatures. Interference caused by DC light entering the forward-scatter-mask (FSM) apertures may result in pulse-amplitude variability at the affected channel(s). Masks that may be used for differential Mie-scatter analysis may have one shallow-scatter angle, and one larger-scatter angle, and the shallow-angle may be substantially impacted by DC-light. Thus, the characteristic of this type of interference may be an increase in the variability of the pulse height on that channel. In contrast, interference generated by static debris or defects on the flowcell may cause misshapen pulses, which may have multiple lobes. This type of interference may affect both forward-scatter-channels, and the shape and size of these multi-lobed signals.

One or more embodiments may provide measuring the pulse amplitudes and shapes of the scattered light to gain information about the type and extent of any interference phenomena, and serve as a diagnostic of instrument performance.

Cytometers may be used so that the astigmatic beam is focused in the X-dimension on the forward-scatter mask so that a minimum of non-scattered light is incident on the forward-scatter-apertures. However, one or more embodiments may provide the cytometer may be deliberately defocused so that non-scattered light does enter one or more of the forward-scatter-apertures. The interaction of coherent scattered and non-scattered light may lead to temporal and spatial intensity changes in the light detected at the forward-scatter photodetectors, which may result in asymmetric pulse shapes being generated by simple particles. These variations in pulse shape may provide additional information about the size and shape of the particles being measured.

One or more embodiments of the cytometer include a sheathless flow-cell that enables bidirectional flow of sample in the flowcell. Thus in some embodiments, particles in the flowcell may be flowed in both directions. Furthermore, as has been described, in one or more embodiments, the focus of the beam at the forward-scatter-mask may be altered, either by adjusting the distance between L1 and L2, or by translating the forward scatter mask or the flowcell in the Z-axis, parallel to the beam. The ability to adjust the focus of the beam at the forward scatter mask, coupled with the ability to flow the same sample through the same flowcell multiple times, may enable the system to interrogate the beam when it is focusing at different planes, and therefore when measuring different amounts of interference.

FIG. 13 depicts, according to one or more embodiments, when a beam is defocused on the forward scatter mask such that un-scattered light enters one or more of the forward-scatter-mask apertures, an asymmetric pulse shape may result from a simple spherical particle, according to one or more embodiments. When the beam is focused, a more symmetric pulse may be observed, according to one or more embodiments, and when the beam is defocused again, and the flow may be reversed in the flowcell, a different sort of asymmetry may be observed, according to one or more embodiments. System 1310, system 1320, and system 1330 are shown in a system top view 1395. System 1310 shows a defocused beam for a first flow direction, system 1320 shows a focused beam in either flow direction, and system 1330 shows a defocused beam in a second flow direction. System 1310 includes collimated beam 1315, focusing lens 1316, cylindrical lens 1317, flowcell 1318, forward scatter mask 1319, and resulting pulse shape 1351. Collimated beam 1315 goes through focusing lens 1316 and through cylindrical lens 1317 and through flowcell 1318 and collimated beam 1315 is defocused on the forward scatter mask, an asymmetric pulse shape results from a simple spherical particle seen on resulting pulse shape 1351.

System 1320 includes collimated beam 1315, focusing lens 1316, cylindrical lens 1317, flowcell 1318, forward scatter mask 1319, and resulting pulse shape 1352. Collimated beam 1315 goes through focusing lens 1316 and through cylindrical lens 1317 and through flowcell 1318 and collimated beam 1315 is focused, a more symmetric pulse is observed results seen on resulting pulse shape 1352.

System 1330 includes collimated beam 1315, focusing lens 1316, cylindrical lens 1317, flowcell 1318, forward scatter mask 1319, and resulting pulse shape 1353. Collimated beam 1315 goes through focusing lens 1316 and through cylindrical lens 1317 and through flowcell 1318 and collimated beam 1315 is defocused again, and the flow is reversed in the flowcell, a different sort of asymmetry is observed, as seen in resulting pulse shape 1353.

FIG. 14A depicts, according to one or more embodiments, flow in a first direction results in the asymmetric pulse shape shown, including the pulse measured by forward-scatter-detector one (FSC1) which may exhibit a peak followed by a trough, and forward-scatter-detector two (FSC2) which may have a single peak with a shallower slope on the leading edge. Graph 1401 may include flow direction 1410, FSC1 detector voltage pulse 1411, and FSC2 detector voltage pulse 1412. Graph 1401 may include FSC1 amplitude vs. time for 4 um particles when the DC light on the FSM is received into the forward-scatter mask apertures.

FIG. 14B depicts, according to one or more embodiments, reversing the direction of flow, resulting in reversal of the asymmetric pulses so that the FSC2 pulse may have a trough followed by a peak, and FSC1 which may have a steeper slope on the leading edge. Graph 1402 may include flow direction 1420, FSC1 voltage pulse 1421, and FSC2 voltage pulse 1422. Graph 1402 may include FSC1 amplitude vs. time for 4 um particles when the DC light on the FSM is received into the forward-scatter mask apertures.

FIG. 15 depicts a bidirectional cytometry sampling system, according to one or more embodiments. System 1500 includes a sample holder 1505, drain valve 1510, waste port 1515, reusable cup with whole blood sample 1520, pipettor 1525, waste tube 1530, waste pump 1535, flowcell tube 1540, flowcell 1550, sample loop 1555, selector valve 1560, cleaning pump 1565, cleaning solution 1570, high-precision pump 1575, and system fluid 1580. Sample loop 1555 may include for example a length of tubing sized to hold a volume of liquid. Pipettor 1525 may include a gantry robot. A whole blood sample may flow through pipettor 1525 in flow direction 1545 into reusable cup with whole blood sample 1520.

Reusable cup with whole blood sample 1520 is connected by a tube, for example, flowcell tube 1540, to one end of the flowcell 1550. The other end or opposite end of the flowcell 1550 may be connected to a length of tubing that serves as a sample loop 1555. The sample loop 1555 may have a volume large enough to hold the volume of the aspirated sample, and has an inner diameter (ID) big enough that the sample loop 1555 does not appreciably contribute to pressure drop during flow. For example, the sample loop 1555 may be an FEP tube having an ID of 0.030″ (762 um). The other end or opposite end of the sample loop may be connected to a 3-way switching valve or selector valve 1560 that may switch between a high-precision pump 1575, filled with system fluid 1580, and a low-cost cleaning pump for example cleaning pump 1565. The high-precision pump 1575 may be a piston pump or syringe pump. The low-cost cleaning pump may be a membrane pump or peristaltic pump.

System 1500 may include that a collimated laser may be configured to shine through one or more focusing optics onto the flowcell, and that a beam (for example, including collimated beam 1315) on the flowcell enables particles in the channel within an optical detection window to be detected.

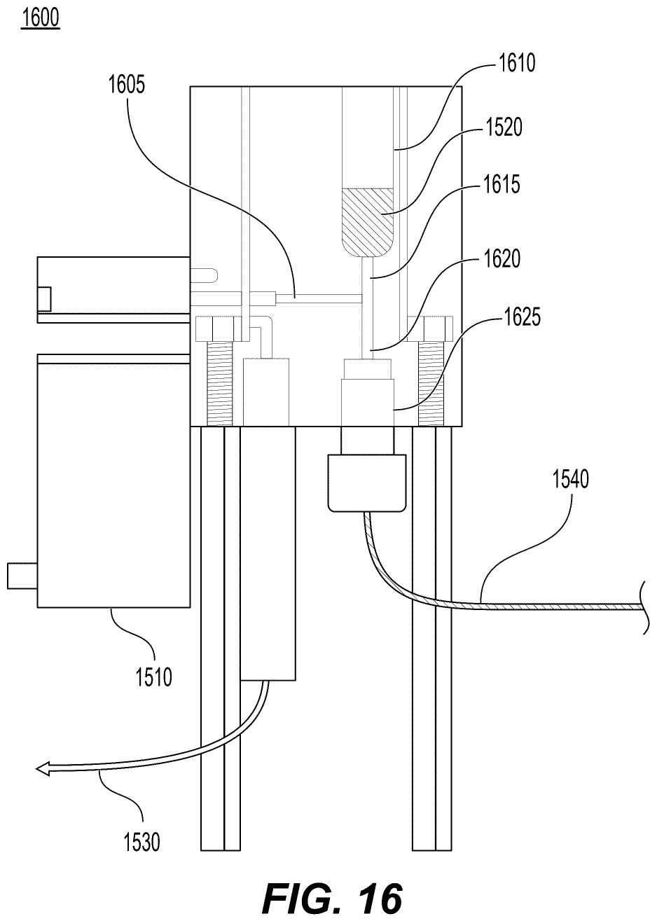

FIG. 16 depicts a reusable sample holder, according to one or more embodiments. System 1600 may include waste channel 1605, sample holding cup 1610, which may be a reusable cup with whole blood sample 1520, T-junction 1615, entry channel 1620, fluidic fitting 1625, flowcell tube 1540, drain valve 1510, and waste tube 1530.

FIGS. 17A-17I depicts steps involved in bidirectional sample analysis using the sheathless flow cytometry system, according to one or more embodiments. FIGS. 17A-17I may utilize system 1500 or system 1600 for operation of the cytometry system. FIGS. 17A-17I include T-junction 1615, sample loop 1555, high-precision pump 1575, flowcell 1550, pipettor 1525. Sample loop 1555 may include for example a sample loop.

FIG. 17A depicts operation 1701 using system 1500 or system 1600. Operation 1701 includes in the initial state, the sample loop, flowcell, and tubing may be filled with system fluid, and the sample holding cup may be empty and clean.

FIG. 17B depicts operation 1702 using system 1500 or system 1600. Operation 1702 includes the pipettor 1525 dispenses a sample (e.g. of whole blood) in direction 1710 into the sample-holding cup. Air gap 1750 may be present. Air gap 1750 may be of known size separating a sample from a fluid of the system 1500 or system 1600.

FIG. 17C depicts operation 1703 using system 1500 or system 1600. Operation 1703 includes that high-precision pump 1575 may aspirate the sample through the flowcell in a direction 1715 into the sample loop 1555 at the desired flow rate, while sample measurements may be made with the laser having a particular intensity, and the filters are in a particular state.

FIG. 17D depicts operation 1704 using system 1500 or system 1600. Operation 1704 includes after measurements are finished, the high-precision pump 1575 may optionally reverse direction and push the sample back through the flowcell in a direction 1720. The flow rate, laser power, and filter-states may be kept the same, or may be changed, configurable to user input. More measurements may be made during this push-step.

FIG. 17E depicts operation 1705 using system 1500 or system 1600. Operation 1705 includes that operation 1703 and 1704 may be repeated as desired, with the sample being first pulled and then pushed through the flowcell by the high precision pump. During each pass through the flowcell new measurement parameters may be used. For example, the laser power may be turned up or down, the flow rate may be increased or decreased, and filters may be inserted or removed from the optical path. Operation 1705 includes air gap 1760. Air gap 1760 may be of known size separating a sample from a fluid of the system 1500 or system 1600.

FIG. 17F depicts operation 1706 using system 1500 or system 1600. Operation 1706 includes after all measurements are completed the pump may push the entire sample back into the sample-holding cup.

FIG. 17G depicts operation 1707 using system 1500 or system 1600. Operation 1707 includes the normally closed waste valve may then open and the waste pump (not shown) may be used to pull fluid from the holding cup through the waste channel to waste in a direction 1725.

FIG. 17H depicts operation 1708 using system 1500 or system 1600. Operation 1708 includes cleaning the flowcell and the sample cup, including if a specialized cleaning fluid is required, the selector valve (not shown) may be switched so that the fluid path is open to a cleaning pump. The cleaning pump (not shown) then pushes the cleaning fluid through the sample loop and flowcell to the holding cup. Then the waste valve may be opened and the holding cup may be drained through the waste channel.

FIG. 17I depicts operation 1709 using system 1500 or system 1600. Operation 1709 includes after the sample cup is sufficiently cleaned, the selector valve (not shown) may be switched back so that the fluid path is connected to the precision system-fluid pump. System fluid may then be pushed through the sample loop, and flowcell to the holding cup. Again, the waste valve may then be opened, and the holding cup may be drained through the waste channel. As a final cleaning step, the pipettor may be used to dispense additional system fluid into the holding cup. Afterwards, once again, the waste valve may be opened, and the holding cup may be drained through the waste channel. In some embodiments, it may be unnecessary to flow a specialized cleaning fluid through the flowcell. Rather, it may be sufficient to flush the sample loop and flowcell with system fluid. This may include, for example, flow direction 1730 and flow direction 1735. In these embodiments, the selector valve, cleaning pump, and cleaning fluid reservoir may not be required.

FIGS. 18A-18B illustrate one embodiment of this invention that uses a motor and a camshaft to insert and retract two filter-sliders into the side-optics path, according to one or more embodiments. The filters may be polarizing, wavelength-selective, or neutral density filters, depending on the information about the cells that is desired. The motor may be driven through software, so that different filters may be automatically positioned in the optical train at different times during a test.

For example, one way of differentiating eosinophils and neutrophils from each other may be to measure the change in polarization that results from scattering events. However, the polarizing filter attenuates fluorescent light that may be used for distinguishing other types of cells from each other. One or more embodiments provide the ability to automatically insert and retract filters, coupled with the ability to flow the same particles through the flowcell multiple times. This means that the systems and methods described herein may use a single detector equipped with both a fluorescence emission filter and a polarization filter, and insert each as needed.

FIG. 18A depicts a view of a cytometer including motorized cams interacting with two filter-sliders, according to one or more embodiments. System 1800 includes a cytometer with motorized cams interacting with two filter-sliders. System 1800 includes first filter slider 1801, second filter slider 1802, motor 1805, and cams 1810.

FIG. 18B depicts an internal view of the side-scatter optical path, illustrating the position of the filter-sliders with respect to the optical path, according to one or more embodiments. The measurement parameters with which the sample is interrogated may be changed with each pass of sample through the flowcell. For example, the laser power may be turned up or down and the flow rate can be increased or decreased. Furthermore, with each pass of the sample through the flowcell, different filters can be automatically inserted or removed from the optical path. System 1800 includes fluorescent or scattered light originating at a particle flowing in flowcell 1812, and propagating through beam splitter 1814, and mirror 1816. Light reflected from beam splitter 1814 propagates to detector 1824. Light reflected from mirror 1816 propagates through filter-slider one 1831, and filter-slider two 1832, before being received at detector 1826. One or more filters may instead or in addition be positioned between beam splitter 1814 and detector 1824.

FIG. 19 depicts a cytometry sampling system using a simplified sample holder, according to one or more embodiments. System 1900 includes waste pump 1535, pipettor 1525, flowcell 1550, sample loop 1555, selector valve 1560, cleaning pump 1565, cleaning solution 1570, high-precision pump 1575, system fluid 1580, sample holder 1905, waste port 1910, sample cup with sample 1915 (such as a whole blood sample), waste flow 1920, waste valve 1925, waste 1930, and sample tube 1935.

With modifications described herein or depicted in the figures, the same use steps illustrated in FIGS. 17A-17I may be used with system 1900. One or more advantages of system 1900 may include the simplicity of the sample cup. Furthermore, the sample tube may not need to be physically connected to the sample holder, it may only be necessary that the end of the sample tube be submerged in the sample during aspiration of the sample into the flowcell. Thus, the system may include fewer connections with potential for leaks, and fewer transitions from one inner diameter to another that may disturb the flow. However, because the sample tube may not be connected to the sample cup, there may be the potential for residual sample volume to be left in the sample cup during aspirate operations.

FIGS. 20A-20E depict views of flowcells, according to one or more embodiments. FIG. 20A depicts a block flowcell in a side view, according to one or more embodiments. A block flowcell 2000 may include taper 2005 and flow-channel 2010, and may include an orientation mark 2015. FIG. 20B depicts a block flowcell in a top view, according to one or more embodiments. FIG. 20C depicts a block flowcell in an isometric view, according to one or more embodiments.

FIG. 20D depicts a capillary flowcell in a projected view, according to one or more embodiments. Capillary flowcell 2050 may include an opening in protective layer 2055 and protective layer 2060. FIG. 20E depicts a capillary flowcell in a top view, according to one or more embodiments. Capillary flowcell 2050 may include flow-channel 2065, protective layer 2070 (which may be a protective layer like protective layer 2055), and capillary walls 2075. A cross-section of capillary flowcell 2050 may be 0.36 mm across.

FIG. 21A depicts an isometric view of a stir-pipettor, according to one or more embodiments, and FIG. 21B depicts a bottom view of a stir-pipettor with a zoomed-in view of the pipette as it is moved in a circular arc, according to one or more embodiments. System 2100 includes motor 2105, coupler with eccentric hole 2110, mounting bracket 2115, flange 2120, and pipette 2125.

FIG. 22 shows an exemplary waste/wash station of the fluidic system of the present disclosure, according to one or more embodiments. System 2200 includes cleaning fluid reservoir 2205, cleaning pump 2210, waste output 2215, extra-cleaning fluid hole 2220, small waste reservoir 2225, deep cleaning hole 2230, shallow cleaning hole 2235, cleaning fluid input 2240, fluid flow 2270, valve 2250, waste tank 2271, and pump 2260. The waste/wash station may be used to clean the pipettors and to deliver cleaning solution to the pipettors for transfer to other parts of the system.

FIG. 23 depicts fluid architecture of an exemplary system of the present disclosure, according to one or more embodiments. FIG. 23 depicts a multimodal system containing the integrated cytometry module 2346 (ICM), ICM valve 2348, ICM sample cup 2345, and ICM pump 2350 that have been described in this disclosure. ICM sample cup 2345 may be the same as that shown in FIG. 16 or FIG. 19. The ICM pump 2350 may be the high-precision pump illustrated in FIG. 15 and FIGS. 17A-17I. The ICM 2346 may contain a block or capillary flowcell, as shown in FIG. 20A-20E.

The multimodal system may also include one or more chemistry modules, such as integrated photometry modules (IPMs) IPM one 2341, IPM two 2342, IPM three 2343, IPM four 2344, for performing clinical chemistry assays. The multi-modal system may also include one or more immunoassay modules 2358 (IAM), and supporting IAM hardware including IAM waste pump bank 2356, IAM wash pump 2314, and IAM wash manifold 2316. The integrated modules may be supported by a common system infrastructure that includes one or more wash stations, and a pipette system for use in processing samples, according to one or more embodiments. Thus, system 2300 may include system fluid tank 2302, degasser 2304, pipette pump one 2306, pipette one 2308, pipette pump two 2310, pipette two 2312, sample holders 2318, consumable cartridge 2320, centrifuge 2322, cleaning fluid tank 2324, cleaning pump 2323, valve 2326, valve 2328, waste/wash station 2331, waste/wash station 2332, waste pump 2352, and waste tank 2354. Waste/wash station 2331 and waste/wash station 2332 may be depicted in FIG. 22. Pipette one 2308 and pipette two 2312 may be those shown in FIG. 21A, and may include stirring capability. Additional system hardware of system 2300 may include more valves, sample holders, and wash pumps, and other components typically used in bioinstrumentation.

FIG. 24A depicts a reagent consumable plate including a cartridge that resembles a well-plate, according to one or more embodiments. The cartridge may be shown with a foil seal on top and with the seal removed on the bottom. This cartridge may contain all the reagents needed for clinical chemistry and hematology assays performed in the cytometry module of the present disclosure. FIG. 24B depicts consumables used by the analytical module, which may include a strip of reaction vessels, and a strip of reagent vessels, according to one or more embodiments. System 2400 includes cartridge 2405, which may be covered by foil-layer 2410, reaction vessel strip 2415, and reagent vessel strip 2420. In some embodiments cartridge 2405 is the only consumable needed to perform all the hematology assays on the cytometry module of the present disclosure. Cartridge 2405 may also contain all the reagents needed to perform all the clinical chemistry assays on the integrated photometry modules (IPMs) of the multimodal system of FIG. 23. In some embodiments the reagent-vessel strip and reaction vessel strip consumables are only needed for immunoassays run on the immunoassay module of the multimodal system of FIG. 23.

One or more embodiments include a cytometer that is low-cost and modular without sacrificing data quality. The optical train described herein may permit uniform interrogation of the entire cross-sectional area of a large-diameter flow-channel, which reduces or eliminates the need for sheath fluid. This may enable the collection of clinical-quality data, while making the system less expensive, more portable, and easier to align and maintain than traditional sheathed cytometers. The sheathless nature of the flow, and the way in which sample is drawn into the flowcell also means that the system includes capabilities of pulling and pushing the sample through the flowcell multiple times, so that with each pass through the flowcell, additional information about the sample may be gathered. This capability is augmented by automated filter-insertion and retraction capabilities of the system and methods described herein, which permit varying the interrogation parameters dynamically during each pass. This means a single channel may be used to gather data sets that would normally require multiple channels on sheath-flow cytometers. Additionally, the sample cup and flowcell may be reusable and may be cleaned between runs in an automated way, reducing costs, and requiring reduced or eliminated user intervention. All these aspects of the invention synergistically form a system that may provide high quality data at low cost.

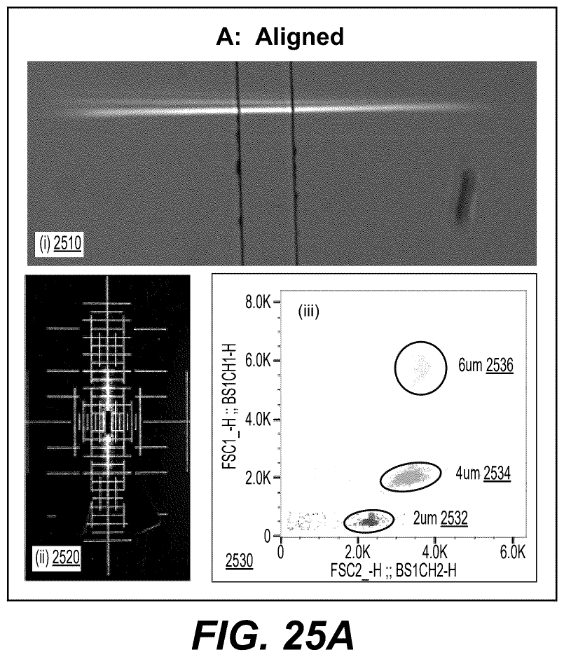

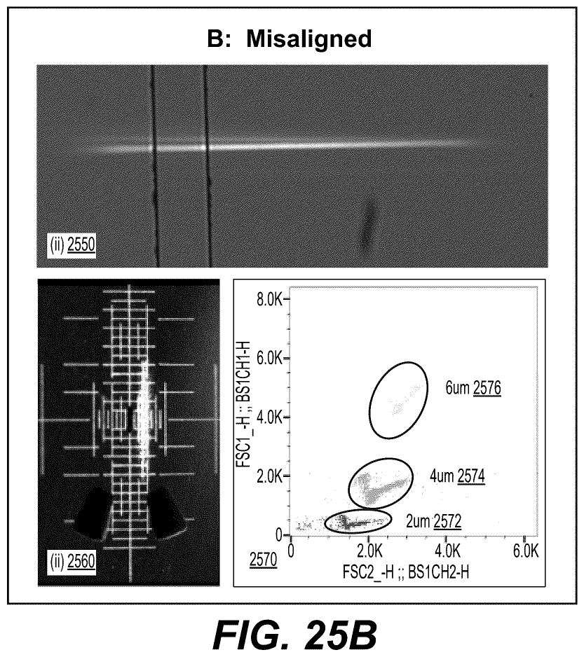

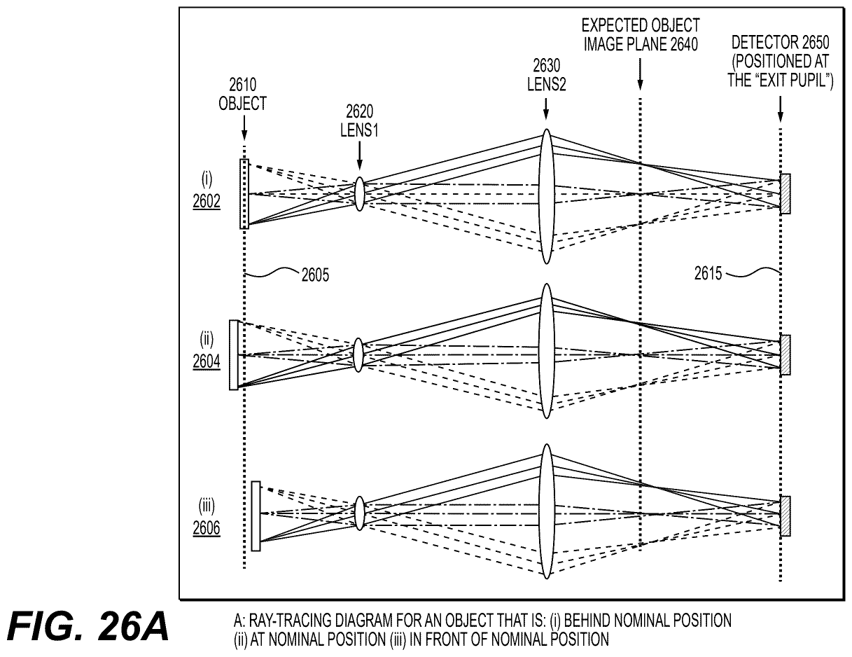

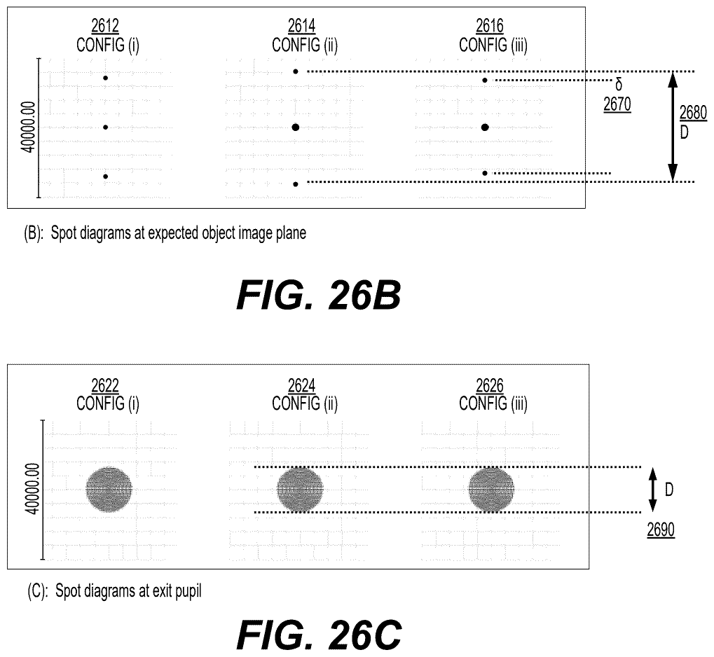

Moreover, the system may be easy to use and maintain, requiring reduced or eliminated intervention from the user between runs. As illustrated in FIG. 25A-25B and FIG. 26A-26C, the cytometer may be tolerant of beam misalignments.

FIG. 25A-B depicts the laser beam on the flowcell and the forward-scatter-mask, along with the scattergram that results from flowing 2, 4, and 6 um diameter beads through the flowcell under these conditions for an aligned state and a misaligned state, according to one or more embodiments. As shown in FIG. 25A-25B, the oversized astigmatic beam that fills the cross-section of the flow-channel still fills the flow channel and interacts with particles, even if it is badly misaligned and off-center. Thus, particles passing through the channel can be counted even if the beam is misaligned.

FIG. 25A depicts a properly aligned laser beam on the flowcell channel and the forward-scatter-mask, along with the scattergram that results from flowing 2, 4, and 6 um diameter beads through the flowcell under these conditions, according to one or more embodiments. FIG. 25A shows the system when the laser beam is aligned. Image 2510 shows the beam centered on the channel in the flowcell. Image 2520 shows the beam centered on the forward scatter mask. Graph 2530 shows the resulting scattergram of FSC1 intensity vs. FSC2 intensity, when 2 um diameter polystyrene beads (outline 2532), 4 um diameter polystyrene beads (outline 2534), and 6 um diameter polystyrene beads (outline 2536) are flowed in the flow channel under these conditions.

FIG. 25B depicts a badly misaligned laser beam on the flowcell channel and the forward-scatter-mask, along with the scattergram that results from flowing 2 um diameter beads (outline 2572), 4 um diameter beads (outline 2574), and 6 um diameter beads (outline 2576) through the flowcell under these conditions, according to one or more embodiments. FIG. 25B shows the system when the laser beam is intentionally misaligned towards the right-hand-side of the flow-channel. Image 2550 shows the laser beam off-center by an amount of approximately 400 microns on the flow-channel. On the forward scatter mask shown in image 2560, the beam is shifted by almost a millimeter. The scattergram of graph 2570 resulting from this misaligned system reveals bead populations that are somewhat distorted, but are still easily gated and counted.

The cytometry module may also accommodate misalignments of the flow-channel with respect to the side-optics.

FIG. 26A-C depicts an exemplary side-optics configuration, with ray-traces and spot diagrams, illustrating how the side optics train may image the exit pupil of the system instead of the object and is therefore insensitive to offsets of particles in the flowcell, according to one or more embodiments.

FIG. 26A depicts an exemplary side-optics configuration and ray-traces representing light coming from an object that is displaced away from the collection lens, at a nominal position relative to the collection lens, and closer to the collection lens, according to one or more embodiments. FIG. 26A shows ray-tracing diagrams and idealized spot diagrams representing three situations in which an object (such as a particle traveling through the channel in the flowcell) is at (position setup 2602), behind (position setup 2604), or in front of (position setup 2606) its nominal object position 2605. The ray tracing diagrams include nominal object position 2605, object 2610, lens one 2620, lens two 2630, expected object image plane 2640, exit pupil position 2615, and detector 2650. Position setup 2602 may include object 2610 at nominal object position 2605. Position setup 2604 may include object 2610 behind nominal object position 2605. Position setup 2606 may include object 2610 in front of nominal object position 2605.

In typical optical systems, an object is imaged onto the detector. When the object shifts from its nominal position, the resulting image plane also shifts. If the detector is fixed at the expected image plane, then the image will be slightly out of focus, and the resulting spots on the detector will be larger, and will be shifted laterally.

FIG. 26B depicts a spot diagram at the expected object image plane, according to one or more embodiments. In particular, FIG. 26B depicts a spot diagram 2612, spot diagram 2614, spot diagram 2616, distance 2670, and spatial extent 2680. FIG. 26B shows idealized spot diagrams resulting from the central and off-axis rays in the three cases illustrated in FIG. 26A. For example, spot diagram 2612 may correspond with position setup 2602, spot diagram 2614 may correspond with position setup 2604, and spot diagram 2616 may correspond with position setup 2606. Spot diagram 2612, spot diagram 2614, and spot diagram 2616 may be spot diagrams at expected object image plane 2640. The object (including the off-axis rays) has a relatively large spatial extent, spatial extent 2680, or “D” on the detector. Furthermore, as the object shifts from behind to in-front-of its expected location, the resulting spots shift by a distance, distance 2670, or 8 on the detector.

In contrast, an imaging system may be configured so that the detector is located at the exit pupil, which images the entrance pupil. This is the situation depicted in FIG. 26C.

FIG. 26C depicts a spot diagram at the exit pupil plane, according to one or more embodiments. Spot diagram 2622 may correspond with position setup 2602, spot diagram 2624 may correspond with position setup 2604, and spot diagram 2626 may correspond with position setup 2606. Spot diagram 2622, spot diagram 2624, and spot diagram 2626 may be spot diagrams at detector 2650 positioned at exit pupil. In this situation the spot from each group of rays is more spread out, but the overall spatial extent of an extended object, spatial extent 2690, or “D,” is smaller than that in FIG. 26B. As the object shifts from behind to in front of its expected location, there is also no movement of the spots.

In some embodiments, therefore, each side optics channel may be configured such that its detector is situated at the exit pupil of the side-optics imaging system. In this configuration, both the intensity and spot-size of light received at the detectors are insensitive to changes in the precise location of the object. Thus, small differences in the location of the flow channel in the flowcell, or of the particle in the flow channel will not impact the precision of the results. Relative to other cytometers, this loosens manufacturing tolerances, making it easier and lower cost to maintain and operate.

Finally, the system is modular. The cytometry module may share system-level resources, such as a gantry robot, pipettor, syringe pumps, waste pump, system fluid tank, waste tank, and other modules in an instrument.

What is claimed is:

1. A module including:
one or more focusing optics;
a flowcell configured to receive one or more particles therein;
a collimated laser configured to shine a beam of light through the one or more focusing optics onto the flowcell, wherein the one or more focusing optics is configured to provide a beam of light from the collimated laser that overfills a width of the flowcell;
a side scatter optical train including one or more optics and one or more side scatter detectors, wherein the one or more side scatter detectors are configured to receive light scattered by the one or more particles in the flowcell;
a forward scatter optical train including a forward scatter mask, one or more optics, and one or more forward scatter detectors, wherein the one or more forward scatter detectors are configured to receive the light scattered by particles flowing in the flowcell; and
a processor configured to capture data from the one or more side scatter detectors and the one or more forward scatter detectors to determine at least one characteristic of the one or more particles received by the flowcell.

2. The module of claim 1, wherein the one or more focusing optics includes a first lens and a second lens, wherein the second lens is a cylindrical lens.

3. The module of claim 1, wherein the one or more focusing optics is configured to focus the beam from the collimated laser into an astigmatic beam onto the flowcell.

4. The module of claim 1, wherein for the one or more focusing optics configured to provide the beam of light from the collimated laser that overfills the width of the flowcell, the beam of light overlaps one or more channel edges of the flowcell, and the beam of light has a size, uniformity, and intensity at the flowcell such that a full cross-sectional area of a channel within the flowcell is illuminated with the beam of the light that is substantially uniform in intensity.

5. The module of claim 1, wherein the forward scatter mask further includes one or more apertures sized and positioned to produce a dual-angle differential scatter Mie map.

6. The module of claim 4, wherein particles in a channel are not confined by sheath fluid, but are free to flow throughout the full cross-sectional area of the channel, and where furthermore, at any point in the full cross-sectional area, they will pass through a laser beam with substantially uniform intensity.

7. The module of claim 1, wherein the one or more focusing optics is configured to provide a beam from the collimated laser on the forward scatter mask having a spatial extent such that the beam substantially avoids one or more forward scatter mask apertures.

8. The module of claim 1, wherein the module also includes an aperture stop and the aperture stop is selected so as to limit a spatial extent of a focused beam on the forward scatter mask, and thereby substantially avoid one or more forward scatter mask apertures.

9. The module of claim 8, wherein the aperture stop is asymmetric and is shaped so as to limit the spatial extent of the focused beam on the forward scatter mask, and thereby substantially avoid one or more forward scatter mask apertures, while maintaining as much power in the beam as possible.

10. A bidirectional cytometry sampling system including:
a sample holder;
a flowcell connected to the sample holder;
a gantry robot including a pipettor configured to pipette a fluid sample into the sample holder; and
a pump system configured to pump one or more fluids in one or more directions through the flowcell;
wherein the flowcell is fluidically connected to the sample holder and the pump system.

11. The bidirectional cytometry sampling system of claim 10, wherein the sample holder further includes:
a sample holding cup;
a T-junction fluidically connected to the sample holding cup;
a waste channel fluidically connected to the T-junction;
a valve fluidically connected to the waste channel;
a port fluidically connected to the valve;
an entry channel fluidically connected to the T-junction;
a fluidic fitting fluidically connected to the entry channel; and
a fluid conduit fluidically connected to the fluidic fitting and the flowcell.

12. The bidirectional cytometry sampling system of claim 10, wherein the pump system further includes:
a selector valve fluidically connected to a sample loop, wherein the sample loop is fluidically connected to the flowcell;
a cleaning pump fluidically connected to the selector valve; and
a pump fluidically connected to the selector valve and a system fluid; wherein the pump is a high-precision pump, a syringe pump, or a piston pump.

13. The bidirectional cytometry sampling system of claim 10, wherein the bidirectional cytometry sampling system further includes:
a sample loop for a sample which is fluidically connected to the flowcell and the pump system.

14. The bidirectional cytometry sampling system of claim 10, wherein the sample holder further includes:
a sample cup;
a sample tube fluidically connected from the flowcell to the sample cup; and
a waste port fluidically connected to the sample cup, wherein the pump system is configured to pump a fluid through the flowcell to the sample cup to clean the flowcell and the sample cup.

15. The bidirectional cytometry sampling system of claim 10, wherein the sample holder further includes a sample cup, wherein the sample cup is configured to enable one or more samples to be loaded into the flowcell with an air gap of known size separating a sample from a fluid of a hydraulic system fluidically connected to the flowcell.

16. The bidirectional cytometry sampling system of claim 10, wherein the sample holder further includes a sample cup, wherein the sample cup is configured to collect a used sample and a used cleaning fluid after a run of the bidirectional cytometry sampling system.

17. The bidirectional cytometry sampling system of claim 10, wherein the sample holder further includes a sample cup, wherein the sample cup is configured to automatically direct a used sample and a used cleaning fluid to a waste and clean the sample cup.

18. A modular sheathless flow-cytometry system including:
a sample holder;
a pipettor configured to pipette a fluid sample into the sample holder;
a pump system configured to pump one or more fluids in one or more directions through a flowcell, the flowcell being fluidically connected to the sample holder and the pump system;
one or more focusing optics;
a collimated laser configured to shine a beam of light through the one or more focusing optics onto the flowcell;
at least one side scatter detector configured to receive light scattered by one or more particles flowing in the flowcell;
at least one forward scatter detector configured to receive the light scattered by one or more particles flowing in the flowcell;
a forward-scatter mask with one or more forward-scatter mask apertures to limit a collection of forward scattered light to a set of defined scatter angles;
a processor configured to capture data received by the at least one side scatter detector and the data received by the at least one forward scatter detector to determine at least one characteristic of the one or more particles received by the flowcell; and
a side-scatter optical path, the side-scatter optical path including:
one or more filters;
an automated system for inserting and removing the one or more filters; and
a controller configured to operate the automated system.

19. The modular sheathless flow-cytometry system of claim 18, wherein the flowcell further includes thicker walls configured to shift one or more contaminating particles away from a beam on the flowcell.

20. The modular sheathless flow-cytometry system of claim 18, wherein the flowcell further includes an enclosure surrounding the flowcell configured to shift one or more contaminating particles away from a beam on the flowcell.

21. The modular sheathless flow-cytometry system of claim 18, wherein the pump system is configured to flow a sample within the flowcell with bidirectional flow, wherein the pump system is further configured to flow a sample fluid one or more times in the flowcell, and wherein with each flow of the sample fluid through the flowcell one or more measurements on the at least one forward scatter detector is made.

22. The modular sheathless flow-cytometry system of claim 21, wherein during each pass of the fluid sample through the flowcell, a configuration of the modular sheathless flow-cytometry system may be changed in an automated way, such as by increasing or decreasing laser power, increasing or decreasing flow rate through the flowcell, or inserting or removing filters from a side optics channel, so that each pass through the flowcell may result in collection of one or more datasets representing different characteristics of the one or more particles flowed through the flowcell.

23. The modular sheathless flow-cytometry system of claim 18, wherein light on the forward-scatter mask is deliberately defocused so that a desired amount of DC light enters at least one of the one or more forward-scatter mask apertures, creating coherent interference with light scattered off particles flowing in the flowcell, and which thereby generates asymmetric pulses on one or more forward-scatter channels.

24. The modular sheathless flow-cytometry system of claim 18, wherein an oversized astigmatic beam that fills a cross-section of a flow channel of the flowcell will still fill the cross-section of the flow channel and interact with the one or more particles flowing therein, even if the beam is misaligned with a center of the flow channel by an amount of up to 400 microns.
